(19) United States
(12) Patent Application Publication
(10) Pub. No.: US 2024/0112525 A1
(43) Pub. Date: Apr. 4, 2024

(54) Electronic Gaming Device and System with Animated Zone Movement for Balanced Bonus Symbol Selections Across Instances

(71) Applicant: Aristocrat Technologies, Inc. (ATI), Las Vegas, NV (US)

(72) Inventors: Daniel Marks, Decatur, GA (US); Hua Xu, Marietta, GA (US)

(21) Appl. No.: 17/958,226

(22) Filed: Sep. 30, 2022

(51) Int. Cl. G07F 17/32

(52) U.S. Cl. CPC G07F 17/3213; G07F 17/3267; G07F 17/34

(57) ABSTRACT

A gaming system including a display having a plurality of reels. A controller controls the display to animate a zone that occupies a subset of the reels, and selects symbols for the zone and the rest of the reels from a first set of symbols including zone symbols, and a second set of symbols both zone symbols and gem symbols, respectively. The first and second symbol sets associated with the reels are shuffled from a current instance to a subsequent instance for a balanced symbol selection. For the current instance, assigned values of zone symbols selected for the zone are collected, but only the assigned values of the gem symbols selected for outside the zone are collected. The zone is expanded for the subsequent instance when enough gem symbols selected for outside the zone are collected.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Technical problems exist involving how a gaming device that may satisfy a designated game return-to-player that either complies with applicable regulations for certain game features or is set to achieve a certain game volatility, where the processor of the electronic gaming device initiates a series of game instances based upon reaching one or more of trigger symbols, where an expandable zone is animated to move within a matrix of display positions without bias when the expandable zone is moved to capture special symbols.

To meet or satisfy a target volatility criterion or designated RTP, the random nature of game determinations based on the occurrence of special symbols may cause redundant processing of the possible destination locations of the expandable zone. Additionally, the confined screen size of many gaming devices creates challenges as to how to effectively communicate to the viewer or player each award is made based on the special symbols captured by the zone when one or more special symbols are selected for displayed, or how the zone is to be expanded to provide additional chances of generating an award using a random number generator.

Further limitations and disadvantages of conventional and traditional approaches will become apparent to one of skill in the art, through comparison of such systems and devices with some aspects of the present disclosure as set forth in the remainder of the present application with reference to the drawings.

### SUMMARY

There is disclosed a gaming device, a method of operating a gaming device and a system where a bonus game provides multiple ways to collect credits accumulated via animated movements of one or more zones of individual reels during instances of the bonus game, while avoiding bias introduced by the movements. In example embodiments, the animated movement is initiated when one or more particular symbols are displayed outside of the zone. After capturing all particular symbols outside of the zone, the animated movement of the zone may stop. However, the position where the zone stops in a current instance may present a technical challenge as to which of particular individual reels outside the zone is used in a subsequent instance, to satisfy game design requirements and/or RTP. As such, providing different reel strips for each of a plurality of individual reels and randomly shuffling the reel strips between instances solves the problem of bias presentation of the zone and/or symbols.

Some embodiments of the disclosure provide a gaming system that includes a display device comprising a plurality of display positions, and a gaming controller having a processor and memory having a first set of symbols including a plurality of first symbols, a second set of symbols including a plurality of second symbols different from the plurality of first symbols, each of the first symbols and the second symbols having one of a plurality of values, and one or more sequences of instructions, which, when executed, cause the processor to at least control the display device to animate a zone among the plurality of display positions including a plurality of zone display positions, and a count of the plurality of first symbols collected outside the zone, control the display device to animate, for a current instance, a first plurality of symbols selected from the first set of symbols for the plurality of display positions outside the zone, and a second plurality of symbols selected from the second set of symbols for the plurality of zone display positions, based on a plurality of random numbers generated by a random number generator, control the display device to animate the values of the second symbols selected for the zone being collected, and the zone being moved based on the first symbols selected outside the zone to acquire the first symbols for an increment of the count, and control the display device for a next instance to animate the zone being expanded into an expanded zone when the count reaches a threshold.

In one aspect, the one or more sequences of instructions, when executed, cause the processor to control the display device to animate the zone being moved in a predetermined path or randomly towards each of the first symbols.

In one aspect, the one or more sequences of instructions, when executed, cause the processor to control the display device to animate each of the values assigned to each of the first symbols being collected when the zone overlaps each of the first symbols.

In one aspect, the one or more sequences of instructions, when executed, causing the processor to award a predetermined plurality of instances when the count reaches the threshold.

In one aspect, the one or more sequences of instructions, when executed, causing the processor to dynamically assign the values to the first symbols and the second symbols.

In one aspect, the one or more sequences of instructions, when executed, causing the processor to dynamically adjust the threshold based on the plurality of zone display positions in the zone.

In one aspect, the one or more sequences of instructions, when executed, causing the processor to shuffle the plurality of display positions and the plurality of zone display positions prior to the current instance.

Some embodiments of the disclosure provide a method of presenting an award in a gaming system having a display device providing a matrix comprising an initial plurality of display positions, and a server having a processor and memory having a first set of symbols, a second set of symbols including a plurality of second symbols, a third set of symbols including a plurality of third symbols different from the plurality of second symbols, each of the second symbols and the third symbols having one of a plurality of values, and one or more sequences of instructions, which, when executed, cause the processor to at least to initiate a game, the method comprising animating a first plurality of symbols selected from the first set of symbols in the matrix for display at the initial plurality of display positions based on a plurality of random numbers generated by a random number generator, animating an expansion of the matrix into an expanded matrix to include an expanded plurality of display positions having an expandable zone that comprises a plurality of zone display positions operable to move towards the second symbols, and a counter indicative of the plurality of second symbols collected outside the expandable zone, when the first plurality of symbols selected include a trigger event, animating, for a current instance, a second plurality of symbols selected from the second set of symbols for the expanded plurality of display positions outside the expandable zone in the expanded matrix, and a third plurality of symbols selected from the third set of symbols for the plurality of zone display positions, based on the random numbers generated, animating the values of the third symbols selected for the expandable zone being collected, and the expandable zone being moved based on the second symbols selected outside the expandable zone to acquire the second symbols for an increment of the counter in a predetermined path or randomly, and animating, for a next instance, the expandable zone being expanded into an expanded zone when the counter reaches a threshold.

In one aspect, the method further comprises animating each of the values assigned to each of the second symbols being collected when the expandable zone overlaps each of the second symbols.

In one aspect, the method further comprises awarding a predetermined plurality of instances when the counter indicates that the threshold has been reached.

In one aspect, the method further comprises dynamically assigning the values to the third symbols and the second symbols.

In one aspect, the method further comprises dynamically adjusting the threshold based on the plurality of zone display positions in the expandable zone.

In one aspect, the method further comprises shuffling the expanded plurality of display positions and the plurality of zone display positions prior to the current instance.

Some embodiments of the disclosure provide a non-transitory computer-readable medium for conducting a game on an electronic gaming device that includes a display device providing a matrix comprising an initial plurality of display positions, and a gaming controller having a processor, and for storing a first set of symbols, a second set of symbols including a plurality of second symbols, a third set of symbols including a plurality of third symbols different from the plurality of second symbols, each of the second symbols and the third symbols having one of a plurality of values, and one or more sequences of instructions, which, when executed cause the processor to perform at least the steps of selecting a first plurality of symbols from the first set of symbols for display in the matrix based on a plurality of random numbers generated by a random number generator, expanding the matrix into an expanded matrix to include an expanded plurality of display positions and a zone having a plurality of zone display positions, and to animate a counter indicative of the plurality of second symbols collected outside the zone, when the first plurality of symbols selected include a trigger event, initiating a current instance of the game including animating a second plurality of symbols being selected from the second set of symbols for the expanded plurality of display positions outside the zone in the expanded matrix, and a third plurality of symbols selected from the third set of symbols in the plurality of zone display positions, based on the random numbers generated, animating on the display device the values of the third symbols selected for the zone being collected, and the zone being moved based on the second symbols selected outside the zone to acquire the second symbols for an increment of the count, and initiating a next instance including animating the zone being expanded into an expanded zone when the count reaches a threshold.

In one aspect, the one or more sequences of instructions, when executed, further cause the processor to perform the step of animating the zone being moved in a predetermined path or randomly towards each of the second symbols.

In one aspect, the one or more sequences of instructions, when executed, further cause the processor to perform the step of animating each of the values assigned to each of the second symbols being collected when the zone overlaps each of the second symbols.

In one aspect, the one or more sequences of instructions, when executed, further cause the processor to perform the step of presenting an award of a predetermined plurality of instances when the counter indicates that the threshold has been reached.

In one aspect, the one or more sequences of instructions, when executed, further cause the processor to perform the step of dynamically assigning the values to the third symbols and the second symbols.

In one aspect, the one or more sequences of instructions, when executed, further cause the processor to perform the step of dynamically adjusting the threshold based on the plurality of zone display positions in the zone.

In one aspect, the one or more sequences of instructions, when executed, further cause the processor to perform the step of shuffling the expanded plurality of display positions and the plurality of zone display positions prior to the current instance.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3A illustrates, in block diagram form, an implementation of a game processing architecture algorithm that implements a game processing pipeline for the play of a game in accordance with various implementations described herein.

FIG. 3B illustrates example reel strip layouts.

FIG. 3C is a flow chart of a symbol selection method.

FIG. 4 is a flow chart of an animated cash collect process.

FIG. 5 to 38 are exemplary screen displays.

### DETAILED DESCRIPTION

Embodiments of the present disclosure represent a technical improvement in the art of electronic gaming devices, systems, and operating for such electronic gaming machines or systems. For example, at least some embodiments of the present disclosure employ a gaming device utilizing a moveable expandable zone to award prizes across instances. However, symbol selections for the zone and outside the zone may be biased in a subsequent instance depending on where the zone finishes in a current instance. As such, some embodiments include a gaming system that has a display with a plurality of reels, and a controller. The controller controls the display to animate a zone that occupies a subset of the reels, and selects symbols for the zone and the rest of the reels from a first set of symbols including zone symbols, and a second set of symbols both zone symbols and gem symbols, respectively. The first and second symbol sets associated with the reels are shuffled from a current instance to a subsequent instance for a balanced symbol selection such that volatilities and RTPs may be evenly distributed and easily determined. For the current instance, both the assigned values of zone symbols displayed within the zone and the assigned values of the gem symbols displayed outside the zone are collected. The zone is expanded for the subsequent instance when enough gem symbols selected for outside the zone are collected.

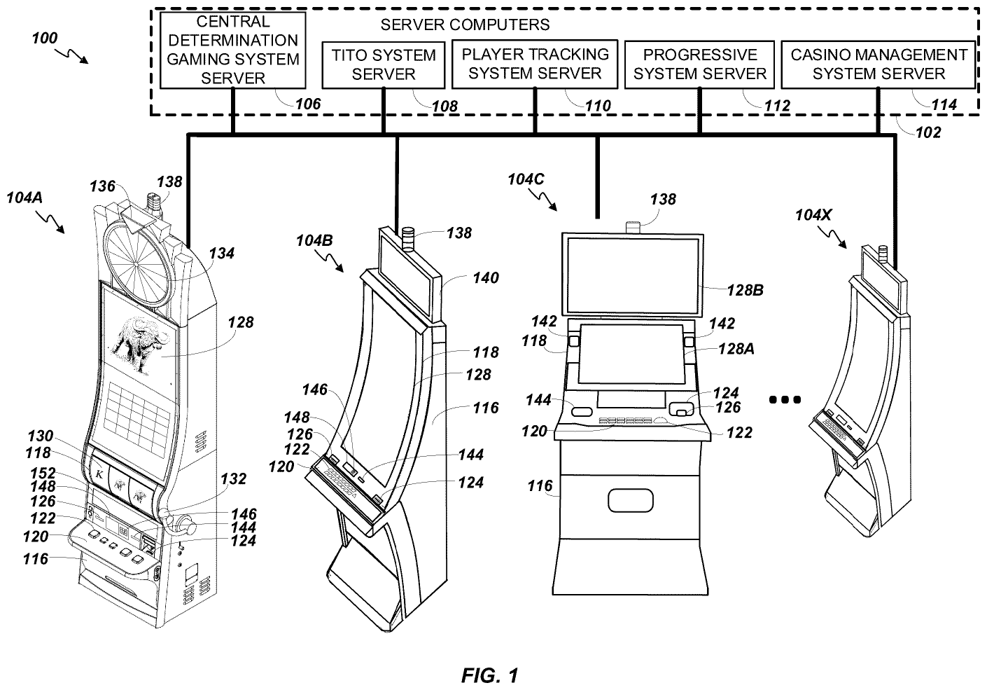

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

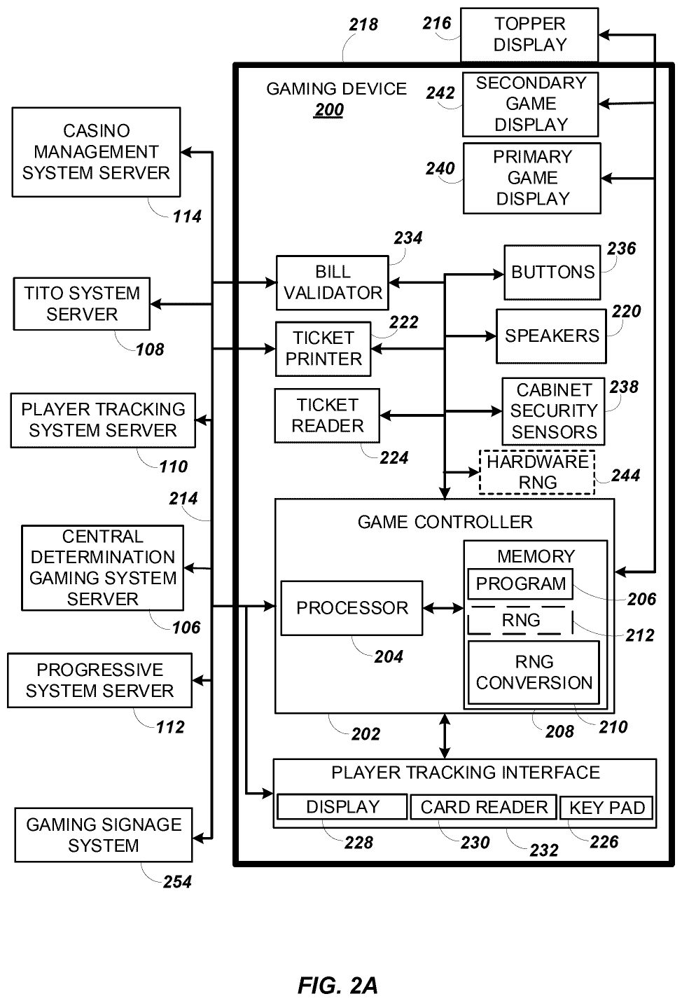

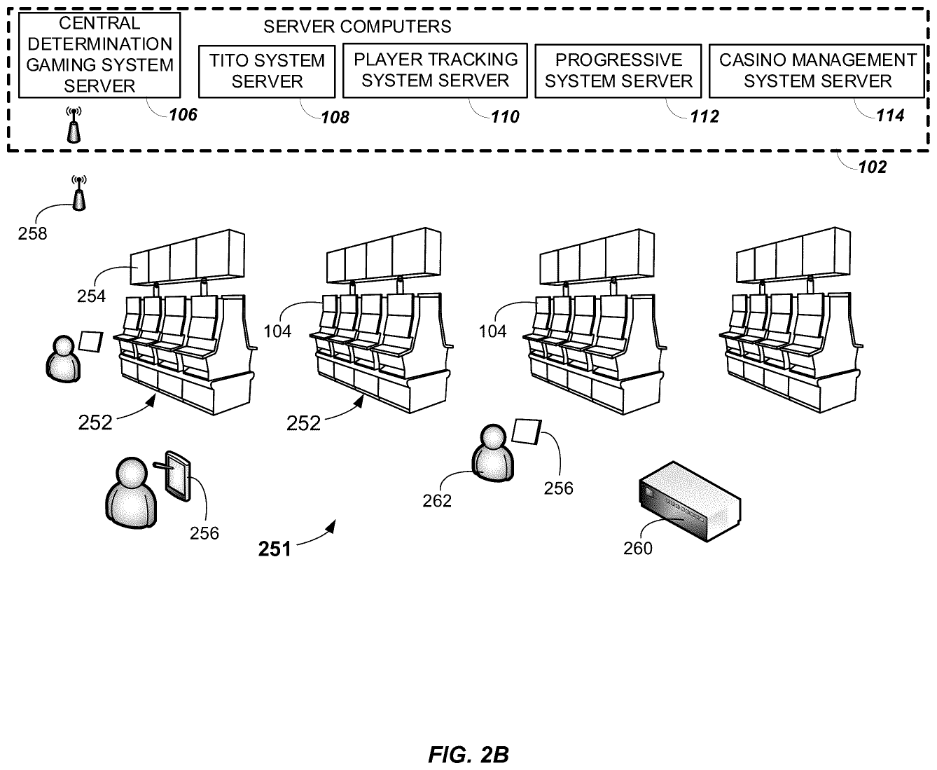

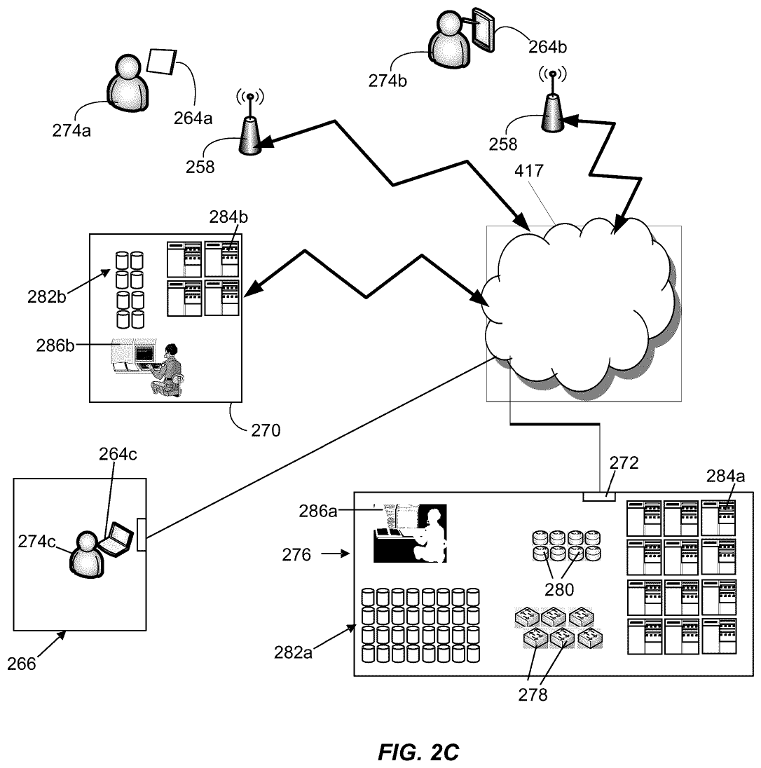

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

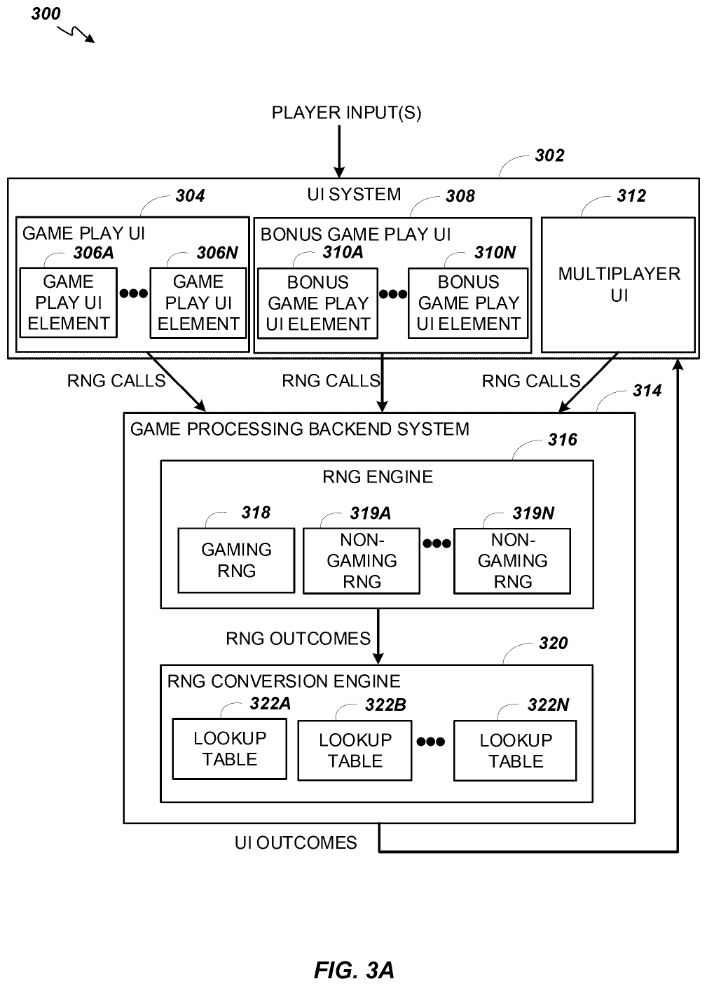

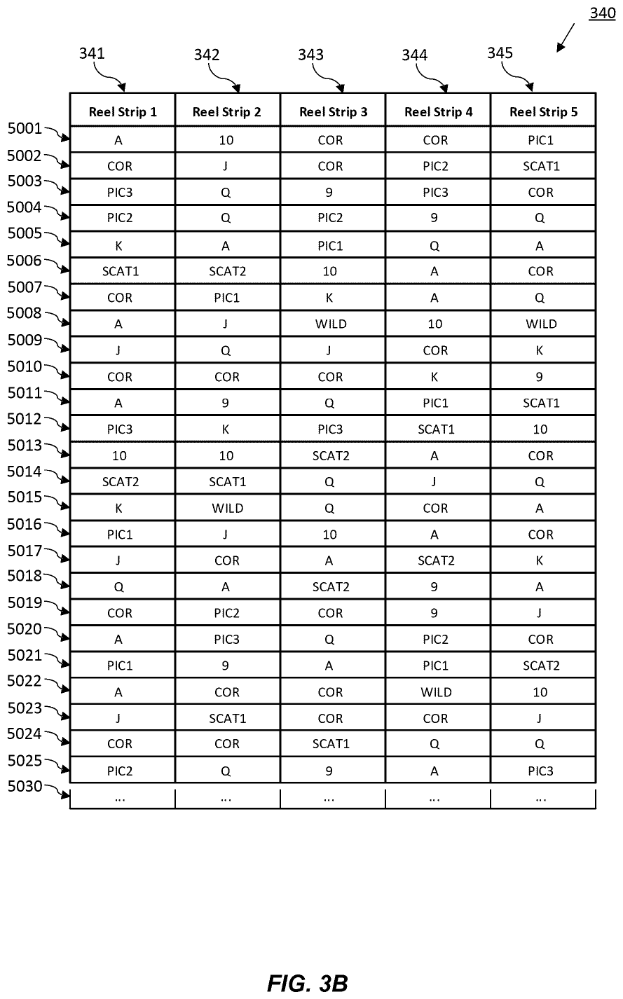

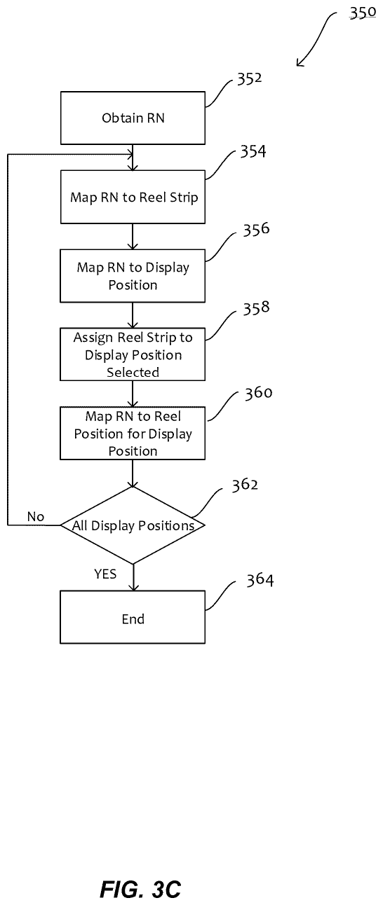

FIG. 3A illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3A also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3A does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

FIG. 3B illustrates an example of a set 340 of five different independent reel strips 341, 342, 343, 344, 345. In some embodiments, a game may employ the five different reel strips for symbol selections for different columns of display positions. In other embodiments, a game may employ one or more reel strips for each of a plurality of individual reels. Although five reel strips are shown, different numbers of reel strips, or only one reel strip may be used. In the example, for illustrative purposes, twenty-five reel strip positions 5001-5025 are shown for each of the reel strips 341, 342, 343, 344, 345. Each reel strip position of each reel has a symbol. For example, a “Wild” symbol occupies the twenty-first reel strip position 5021 of the fourth reel 344. In some embodiments, the symbols shown on the reel strip are generally indicative of symbols that may be employed. In other embodiments, however, other reels strips where two or more wild symbols are placed at consecutive reel strip positions may be employed. Symbol position 5030 indicates that the reel strips 341, 342, 343, 344, 345 may have more symbols than illustrated. For example, the reel strips 341, 342, 343, 344, 345 could have between 30 and 100 reel strip positions with the last reel strip position of a respective reel strip being treated as contiguous with the first reel strip position 5001 as would be the case with a mechanical reel. The actual lengths or the number of reel strip positions of the game reel strips depend on factors such as the lengths of the stacks, the number of wild symbols (in general, the more wilds there are, the longer the reel strip needs to be to maintain the target RTP), and volatility (in general, the higher the prize value is, the longer the reel strip needs to be to lower the hit rate to maintain the target RTP). In some examples, the reel strips associated with different columns may have different lengths.

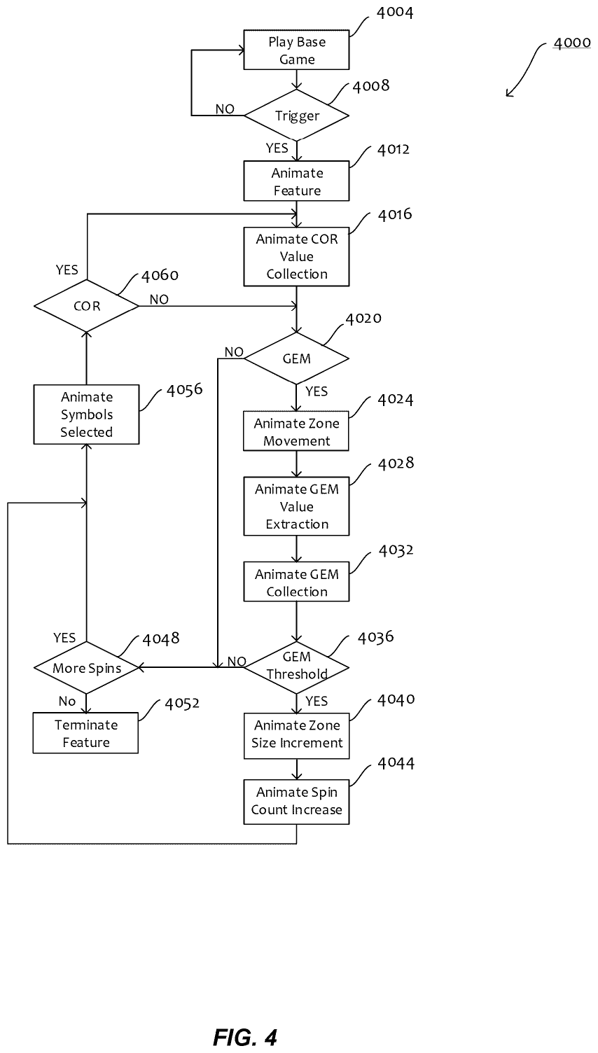

FIG. 3C is a flow chart of an example method 350 carried out by the processor 204 to select symbols from the reel strips for each of a plurality of display positions at step 4056 of FIG. 4 (detailed below). At step 352, the processor 204 starts the process of selecting symbols with obtaining a randomly generated number from a true or pseudo random number generator 212. At step 354, the processor 204 selects one of the reel strips, e.g. one of the five different reel strips shown in FIG. 3B based on the obtained random number. In some embodiments, there may be more or less reel strips to select from as discussed above. To select one of the reel strips, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions. At step 356, the processor 204 maps the random number generated or a different random number to a display position, for example, a first display position. In some embodiments, for example, as shown at step 358, the processor 204 assigns the reel strip selected in step 354 to the display position selected in step 356. In other embodiments, however, the processor 204 may sequentially and randomly select a reel strip and a reel strip position for each individual display position across the matrix of display positions. In this way, a display position randomly acquires a new reel strip for a current game instance in a series of game instances. Alternatively, for each game instance in a series of game instances, every display position or individual reel randomly receives a reel strip. In step 360, the processor 204 randomly selects a reel position among the plurality of reel positions from the selected reel strip for the selected display position. That is, in one game instance, an individual display position receives a reel strip position from a reel strip. However, in a subsequent instance, the individual display position receives another reel strip position from another reel strip. In this way, measured control may be exercised for selecting a reel strip to use with an individual display position, while maintaining a degree of randomness for selecting a reel strip position from the selected reel strip. Thus, such random reel strip and reel strip position selections for individual display positions allow for precise control of satisfying or maintaining a game design, target RTP, target volatility, and/or jurisdictional requirements. In some embodiments, different sets of reel strips may be used for different individual reels or zone. In some embodiments, GEM symbols and COR symbols to be selected for the bonus feature may have higher frequency of being selected while having relatively low randomly or separately determined values. In other embodiments, GEM symbols and COR symbols to be selected for the bonus feature may have mid frequency of being selected while having relatively mid values. In still other embodiments, GEM symbols and COR symbols to be selected for the bonus feature may have low frequency of being selected while having relatively high values. As such, in some embodiments, the bonus feature may include three sets of two reel strips for symbol selections—one set of reel strips is used within the zone, and a different set of reel strips is used outside the zone. For example, in some embodiments, a first set of reel strips may include the GEM symbols with respective assigned values, and a second set of reel strips may COR symbols with respective similarly assigned values. In some embodiments, a plurality of symbols may be selected from the first set of reels strips and the second set of reels strips for display at the matrix of display positions, which will then be evaluated separated based what symbols are displayed within the zone and outside the zone, as discussed below.

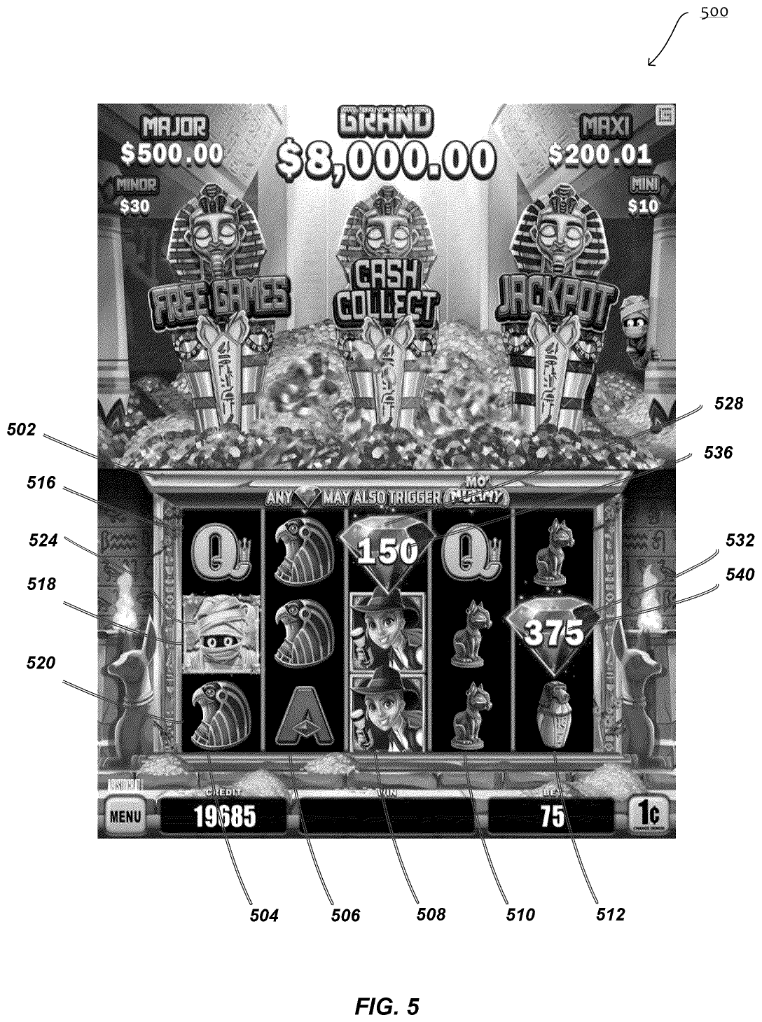

Referring back to FIG. 3A, when the UI outcome yields a bonus game or a feature game, a base game UI is updated or transformed into a bonus game or a feature game UI. FIG. 4 illustrates a flow chart of an animated cash collect process 400 controlling an appropriate UI transitioning from a base game meeting a trigger condition to a bonus game or a feature game. At step 404, the processor 204 initiates a base game instance in response to receiving a wager (e.g. in response to a player making a wager selection using buttons as described above). At step 510, the processor 204 selects symbols for a spinning reel game, and controls the display 240 to display the selected symbols. FIG. 5 shows an example screen display 500 of a base game where symbols are selected for display in a base game matrix 502 having five columns including first column 504, second column 506, third column 508, fourth column 510, fifth column 512, of fifteen symbol positions with three symbols being selected from each reel strip such that there are also three rows including first row 516, second row 518, third row 520 of symbol positions. The example screen display 500 also shows that a first trigger symbol 524 in the form of a mummy has been selected for a reel position defined by the first column 504 and the second row 518, and two GEM symbols 528, 532. The GEM symbols 528, 532 are in the form of diamond symbols with assigned values 536, 540. In some embodiments, a GEM symbol is a special type of COR (“Cash on Reels”) or prize value symbols which are also be termed “configurable” symbols with dynamically assigned values or prize values derived from a look up table by the processor in each game instance. As shown, the GEM symbol includes an assigned value overlaying a diamond symbol.

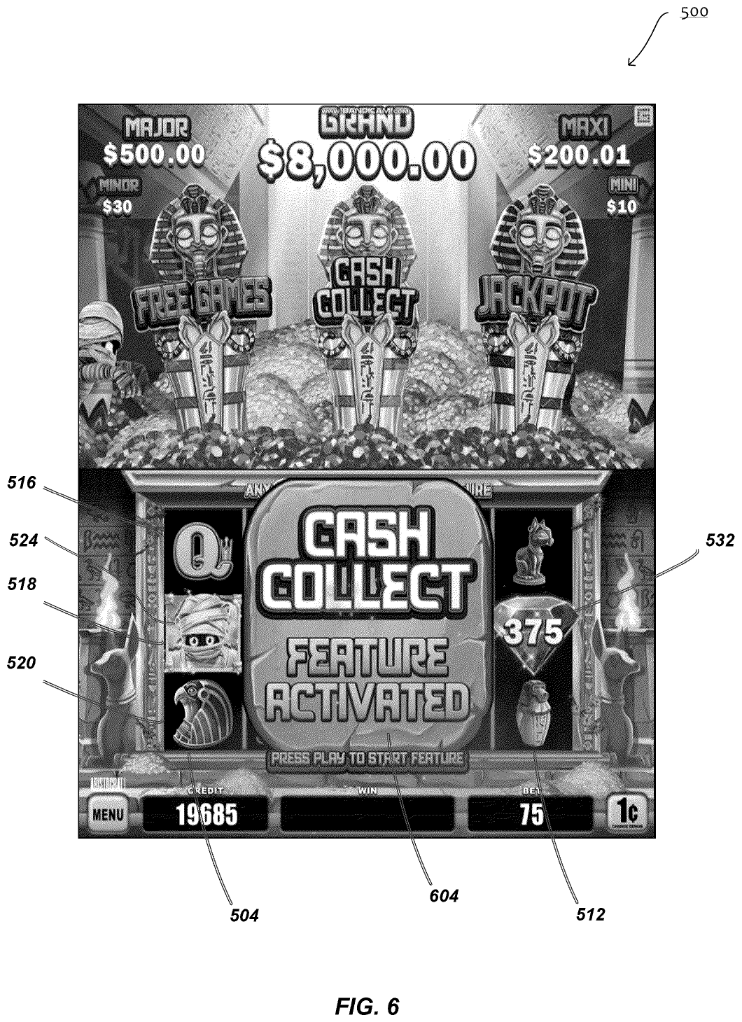

Referring back to FIG. 4, the processor 204 determines at step 408 if a trigger event or trigger occurs. In some embodiments, a trigger may be formed from a trigger symbol appearing in the first column 504, and at least one additional GEM symbol selected for any of the second column 506, third column 508, fourth column 510, fifth column 512. In other embodiments, a random trigger may be used. In still other embodiments, other combinations of symbols displayed, time of play, prizes collected, prize values displayed on the prize value symbols, COR symbols or GEM symbols, a particular trigger symbol, or other events may form a trigger. As shown in FIG. 5, since a complete trigger is formed from the first trigger symbol 524, and the GEM symbols 528, 532, as determined at step 408, the processor 204 proceeds to animate a feature game at step 512. FIG. 6, wherein like numerals refer to like parts, depicts an activation of the feature game with a message 604.

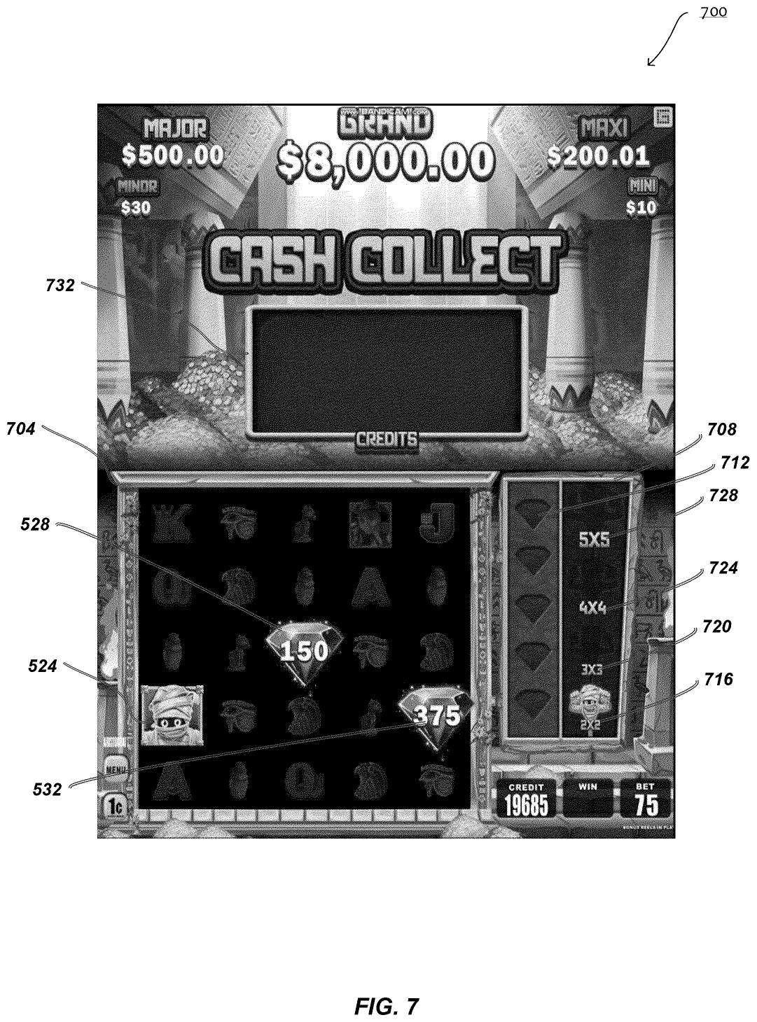

FIG. 7 illustrates an activated feature game screenshot 700, wherein like numerals refer to like parts. The activated feature game screenshot 700 shows that the example screen display 500 is transformed. As shown, the example screen display 500 is animated to undergo an expansion animation expanding from the base game matrix having fifteen display positions to a feature game matrix 704 having five columns and five rows with twenty five display positions, wherein each of the twenty five display positions is an individual reel. FIG. 7 also shows that the feature game matrix 704 retains the first trigger symbol 524 and the GEM symbols 528, 532 after the expansion animation. The activated feature game screenshot 700 also shows a counter 708 with a count to indicate a quantity of diamonds from the GEM symbols to be collected during the feature game. As shown, the count currently has a threshold 712 of five GEM symbols to be collected to advance from a current level to a next level of the feature game. The current level is shown to be a 2×2 zone 716 among four levels including 3×3 zone 720 having a threshold count of four GEM symbols, 4×4 zone 724 having a threshold count of three GEM symbols, and 5×5 zone 728 having a threshold count of two GEM symbols.

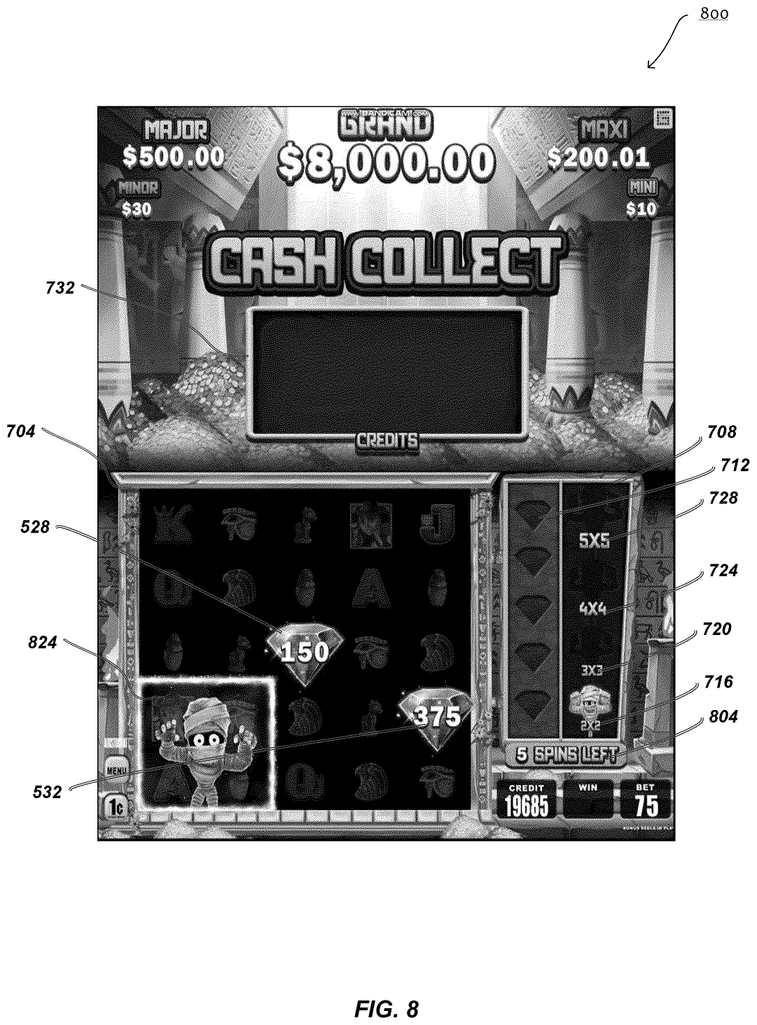

Referring back to FIG. 4, the processor 204 proceeds to animate a non-GEM COR or normal COR collection process at step 4016. As discussed above, each prize value symbol or COR symbol is assigned dynamically a value. When present, the value assigned to a normal COR symbol is collected. However, when the feature game is initiated, only GEM symbols 528, 532 are present, which leads to no normal COR value is extracted or collected at step 4016. FIG. 8 illustrates that the first trigger symbol 524 undergoes an animation of being expanded to be a zone 824 occupying four individual display positions. GEM symbol 528 has been assigned a value 536 of 150 credits, while GEM symbol 532 has been assigned a value 540 of 375 credits. In other embodiments, the bonus feature may start with other zone sizes. For example, the bonus game may start with a symmetric zone such as 1×1 zone, or an asymmetric zone such as 1×2 zone, 2×3 zone, 4×3, 5×4, or the like. The activated feature game screenshot 700 also shows a credit collector 732 that collects qualified credits or values displayed during the feature game. As explained below, only GEM symbols landed outside the zone, and normal COR symbols landed inside the zone will be paid in the bonus feature. In some embodiments, only normal COR symbols may land inside the zone, while both normal COR symbols and GEM symbols may land outside the zone. FIG. 8 also shows a spin counter 804 with five spins have been awarded to initiate the bonus game. In other embodiments, the quantity of spins to be awarded to the bonus game may be determined differently, for example, based on a random number generator, volatility, or an RTP.

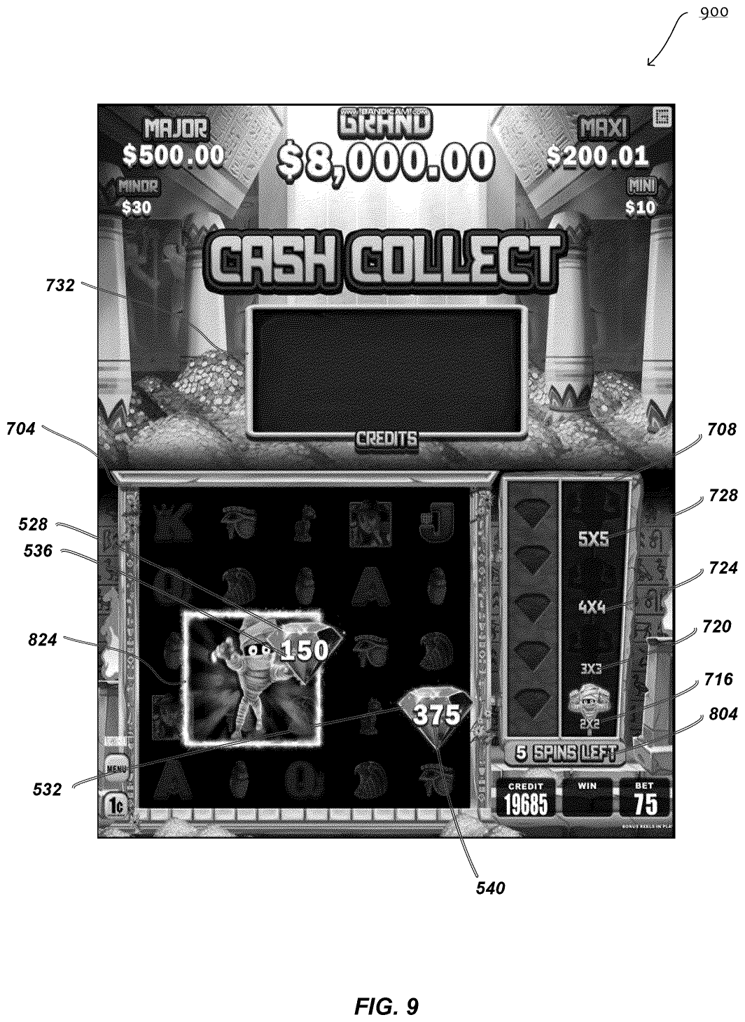

Referring back to FIG. 4, the animated cash collect process 400 proceeds to determine with the displayed symbols include any GEM symbols at step 4020, and to animate a zone movement for collecting values assigned to GEM symbols displayed at step 4024. Since the current instance is a first instance having been triggered from GEM symbols 528, 532, the animated cash collect process 400 proceeds to animate a movement of the zone 824 towards the GEM symbols 528, 532, as illustrated in screenshot 900 of FIG. 9, wherein like numerals refer to like parts. To collect the GEM symbols 528, 532, the zone 824 is animated to move towards GEM symbol 528 having the assigned value 536 of 150 credits. In some embodiments, when two or more GEM symbols have been selected for display, the zone 824 may be animated to move in a predetermined path. For example, tracing the predetermined path may include ranking distances between a current zone position and the GEM symbols, selecting the shortest distance among the distances ranked, and visually moving the zone from the current zone position to the nearest GEM symbol based on the shortest distance located. For another example, tracing the predetermined path may include determining where the zone 824 may stop moving after all the GEM symbols have been captured. However, where the zone 824 stops in a current game instance would present an impact or technical challenge in which reel strips are selected for a particular display position or individual reel in a subsequent game instance, if an order of symbol presentation in pay line (e.g., from left to right) were to be used for determining a win. To avoid the impact of the position of the zone 824, the reel strips for individual reels or display positions are shuffled to allow for a balanced, fair, and truly random presentation of GEM symbols in the subsequent game instance. This allows the game outcome to be minimally impacted by the location of the zone in a previous spin. This also reduces the number of calculations needed to present the next spin and also reduces the calculations needed to calculate the impact of the path of the zone, thereby increasing efficiency. In other embodiments, the zone 824 may be animated to move in a randomly selected path. In still other embodiments, the zone 824 may be animated to move in a player-specified path.

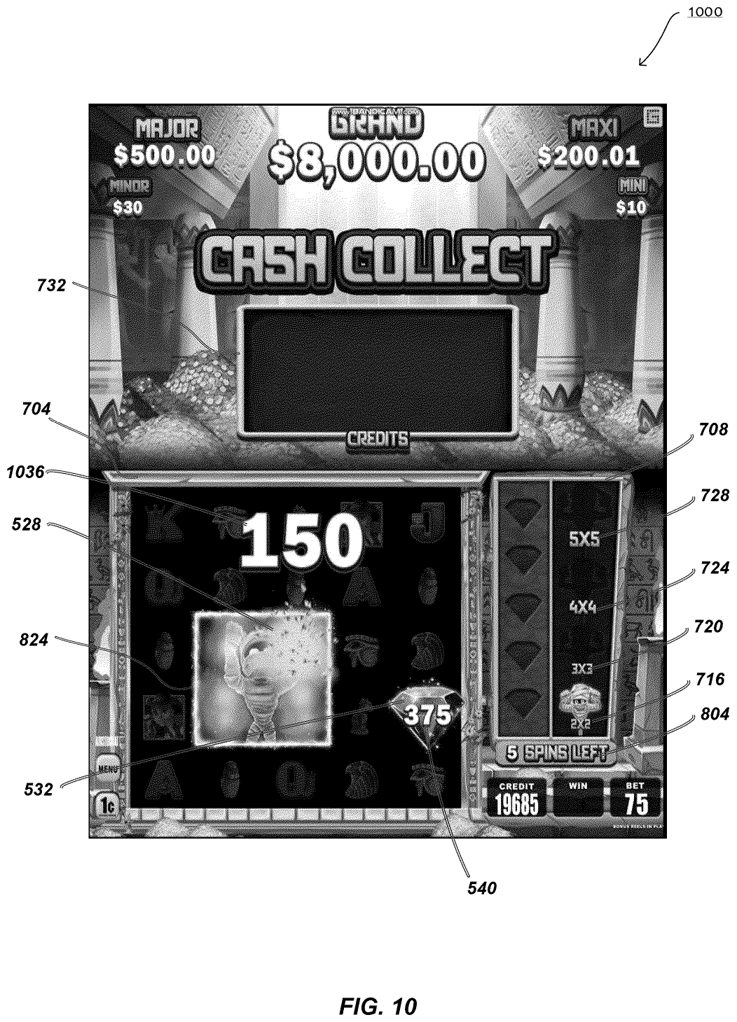

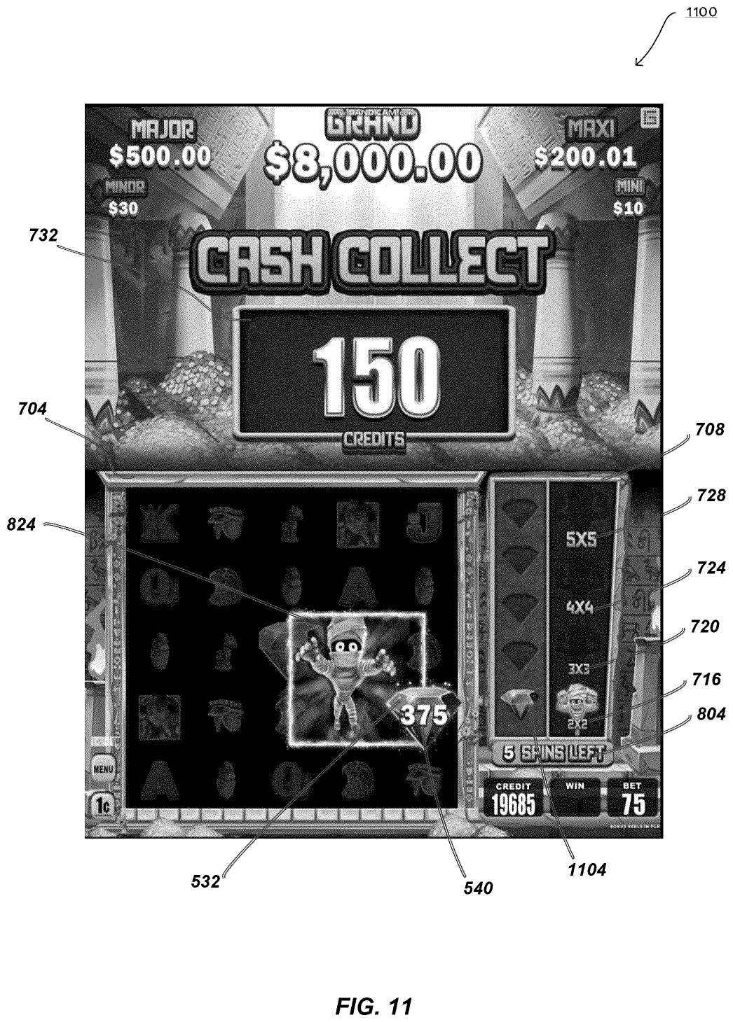

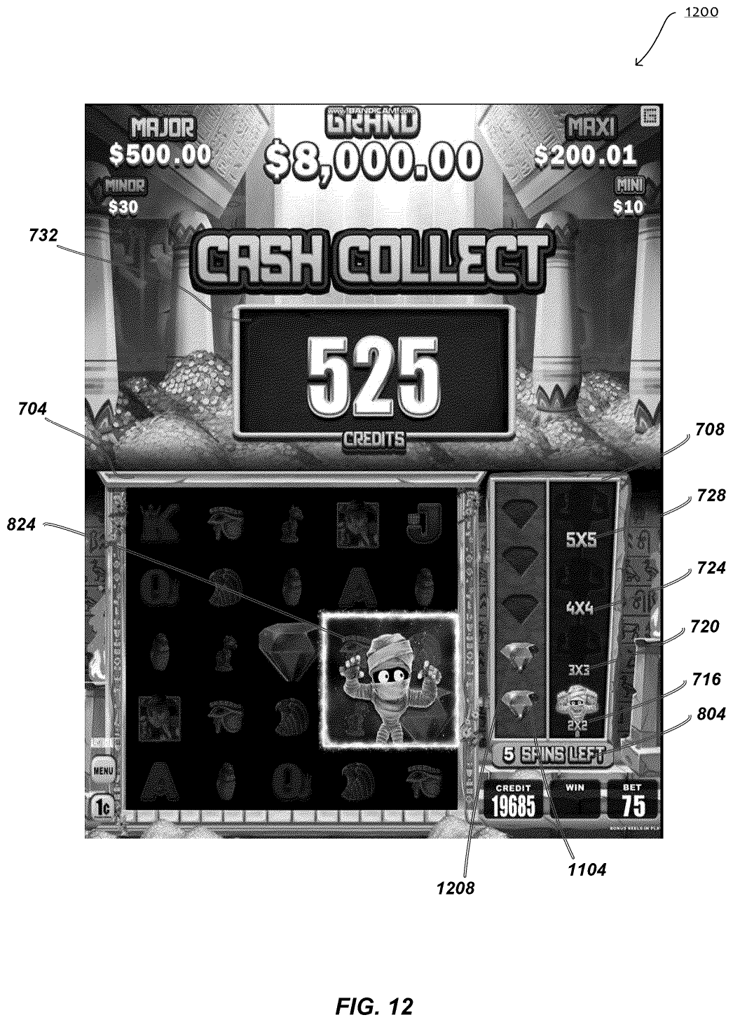

Referring back to FIG. 4, the animated cash collect process 400 proceeds to animate the values being extracted from GEM symbols and collected or accumulated by the credit collector 732 at step 4028, and to animate diamonds from the GEM symbols being counted by the counter 708 at step 4032. For example, as shown in FIG. 10, wherein like numerals refer to like parts, the zone 824 is animated to have overlapped and captured GEM symbol 528. When the zone 824 overlaps GEM symbol 528, the zone 824 is animated to separate or extract the assigned value 536 (shown in FIG. 9) from the GEM symbol 528 yielding an extracted value 936 (of 150 credits) being pushed toward the credit collector 732 for collection. FIG. 11 further illustrates a screenshot 1100 in which the zone 824 continues the movement to collect GEM symbol 532 having value 540 of 375 credits. FIG. 11 also shows that the credit collector 732 has collected the extracted value 936 of 150 credits (of FIG. 10), and the counter 708 has collected one diamond (from GEM symbol 528 of FIG. 9), thus showing a collected diamond 1104. FIG. 12 illustrates a screenshot 1200 in which the zone 824 has extracted the value 540 of 375 credits from GEM symbol 532 resulting in the credit collector 732 showing an accumulated value of 525 credits (from adding 375 credits to the 150 credits shown in FIG. 11). FIG. 12 also shows that the counter 708 has collected a second diamond (from GEM symbol 532 of FIG. 9), thus showing a second collected diamond 1208.

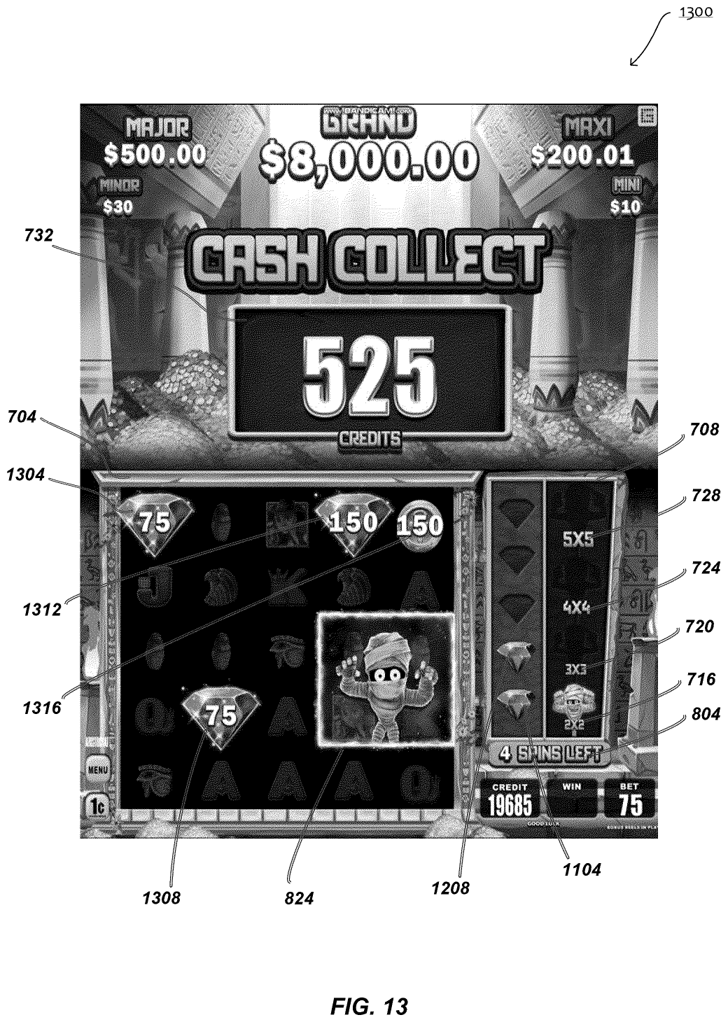

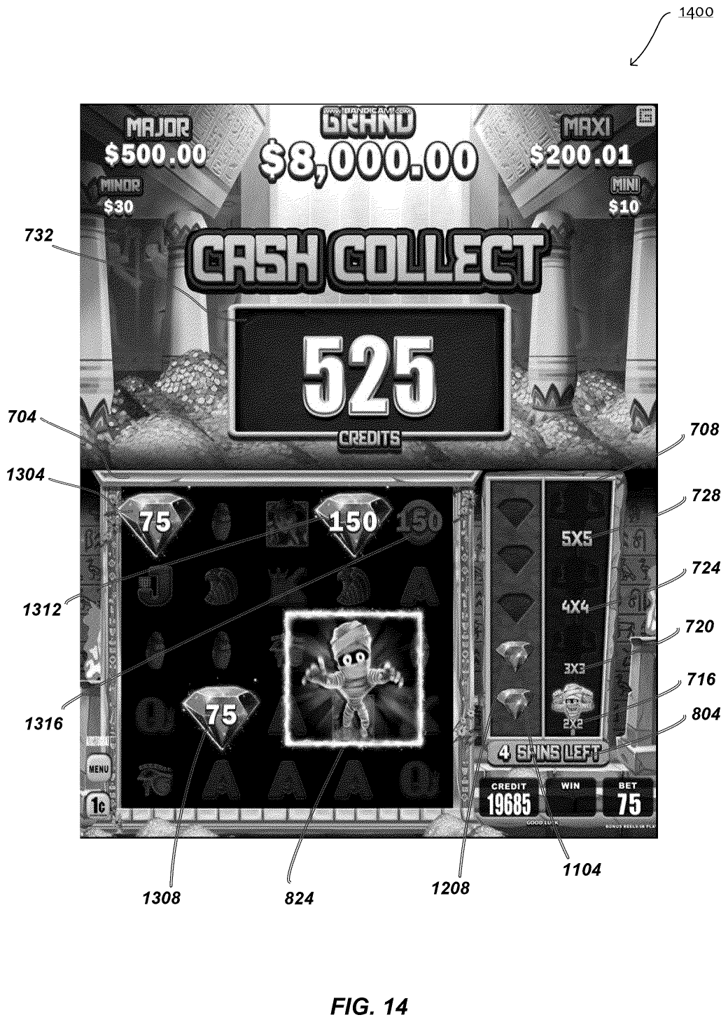

Referring back to FIG. 4, the animated cash collect process 400 proceeds to determine if the count at the counter 708 reaches a threshold at step 4036. As shown in FIG. 12, the counter 708 has a threshold of five diamonds to be collected. Since the counter 708 has only registered two diamonds, 1104, 1208, indicating that the count has not reached the threshold, the animated cash collect process 400 follows the NO path off step 4036, and proceeds to determine if more free games or spins are available at step 4048. When the animated cash collect process 400 determines at step 4048 that more free games or spins are available, the animated cash collect process 400 proceeds to step 4056 to animate symbols being selected for all the individual reels in the zone 824 from a set of reel strips that includes normal COR symbols, and in the feature game matrix 704 but outside the zone 824 from a different set of reel strips that includes GEM symbols and normal COR symbols. FIG. 13, wherein like numerals refer to like parts, illustrates a screenshot 1300 in which the animated cash collect process 400 displays a plurality of symbols selected for the display positions or individual reels. As shown in FIG. 13, GEM symbols 1304, 1308, 1312, and a normal COR symbol 1316 are initially selected for display, while the remaining symbols selected are dimmed. FIG. 14, wherein like numerals refer to like parts, illustrates a screenshot 1400 in which the normal COR symbol 1316 (shown in FIG. 13) has been dimmed since the normal COR symbol 1316 has not landed within the zone 824.

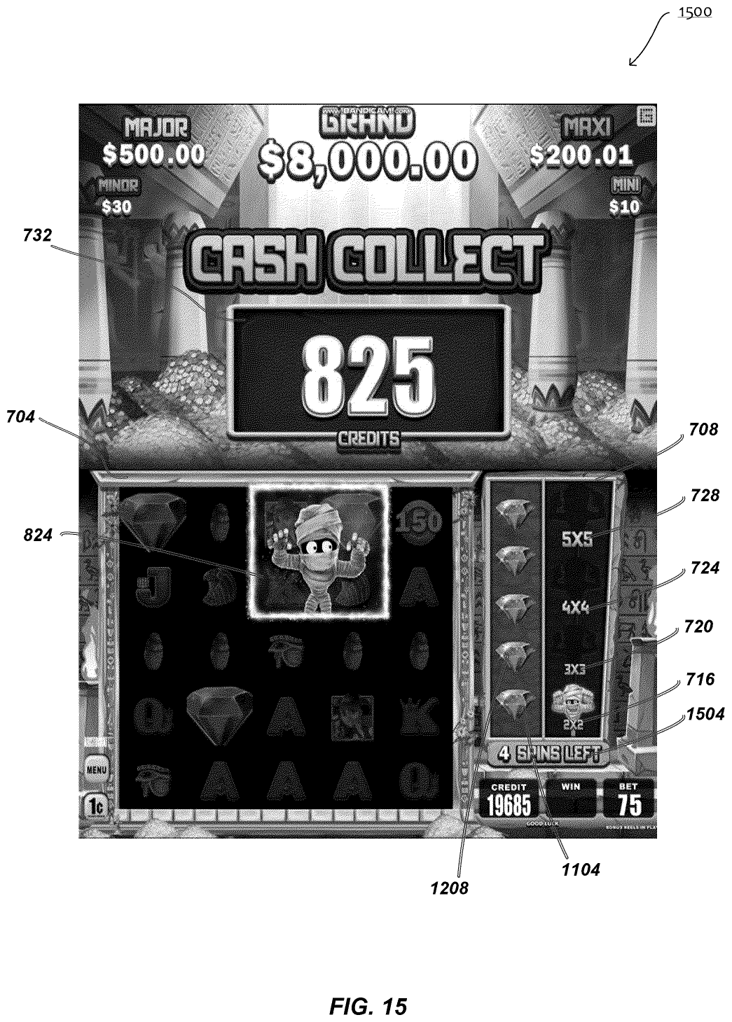

Referring back to FIG. 4, the animated cash collect process 400 proceeds to determine if the zone 824 includes any normal COR symbol at step 4060. As discussed above with respect to FIG. 14, since no normal COR symbol 1316 has landed within the zone 824, the animated cash collect process 400 proceeds to repeat step 4020 to determine if any GEM symbols have landed outside the zone 824 within the feature game matrix 704. However, if normal COR symbols have landed within the zone 824, the animated cash collect process 400 proceeds to animate an extraction of assigned values associated with the normal COR symbols at step 4016, detailed below. FIG. 15, wherein like numerals refer to like parts, illustrates a screenshot 1500 in which the animated cash collect process 400 has added the assigned values of 75 credits, 75 credits, and 150 credits, extracted from GEM symbols 1304, 1308, 1312, respectively, to the credit counter 732 to yield a total of 825 credits. FIG. 15 also shows that three additional diamonds have been collected, and counted toward the counter 708, and a spin counter 1504 with four spins remaining.

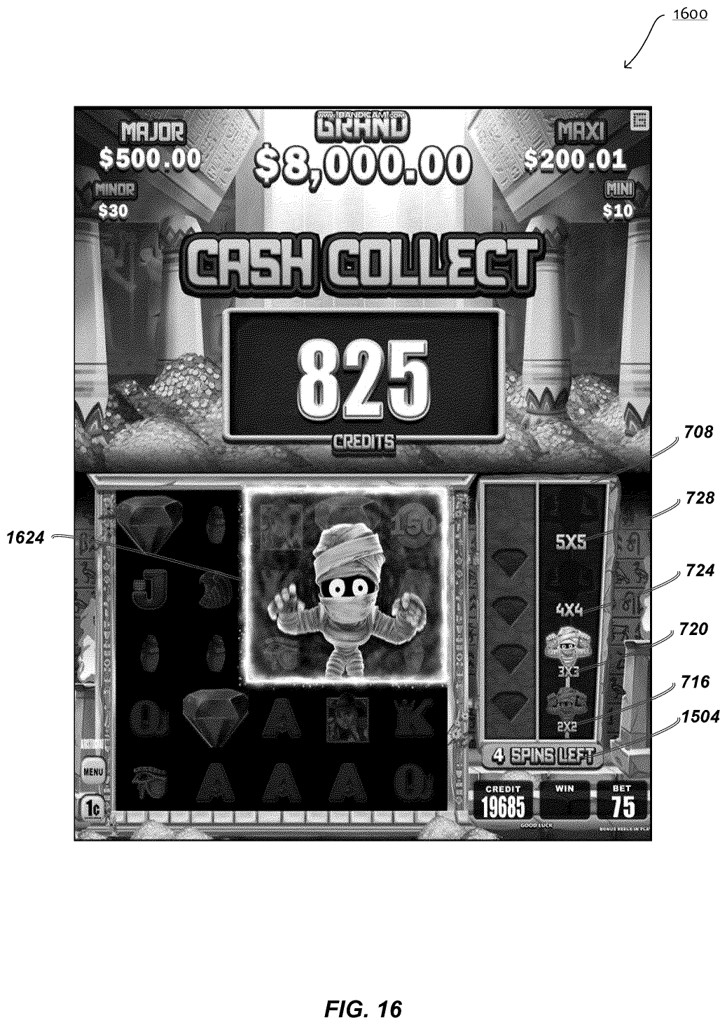

Referring back to FIG. 4, the animated cash collect process 400 proceeds to determine if the count at the counter 708 reaches a threshold at step 4036. As discussed above, the counter 708 has a threshold of five diamonds to be collected. Since the counter 708 has now registered five diamonds, indicating that the count has reached the threshold for the current level 716, the animated cash collect process 400 follows the YES path off step 4036, and proceeds to step 4040, in which the zone 824 undergoes an expansion animation process. In the expansion animation process, an unexpanded zone is animated to expand to yield an expanded zone, depending on a number of diamonds that have been collected. FIG. 16, wherein like numerals refer to like parts, illustrates a screenshot 1500 in which the zone 824 (of FIG. 15) has been expanded into an expanded zone 1624. Additionally, the zone 824 (of FIG. 15) is shown to occupy four display positons or individual reels, whereas the expanded zone 1624 occupies nine display positions or individual reels. FIG. 16 also shows that the feature game has transitioned in the second level 720, which has a threshold of four diamonds. In the embodiment shown, the threshold for a current level is predetermined to satisfy a target volatility criterion or designated RTP. However, in other embodiments, the threshold may be determined dynamically and/or randomly.

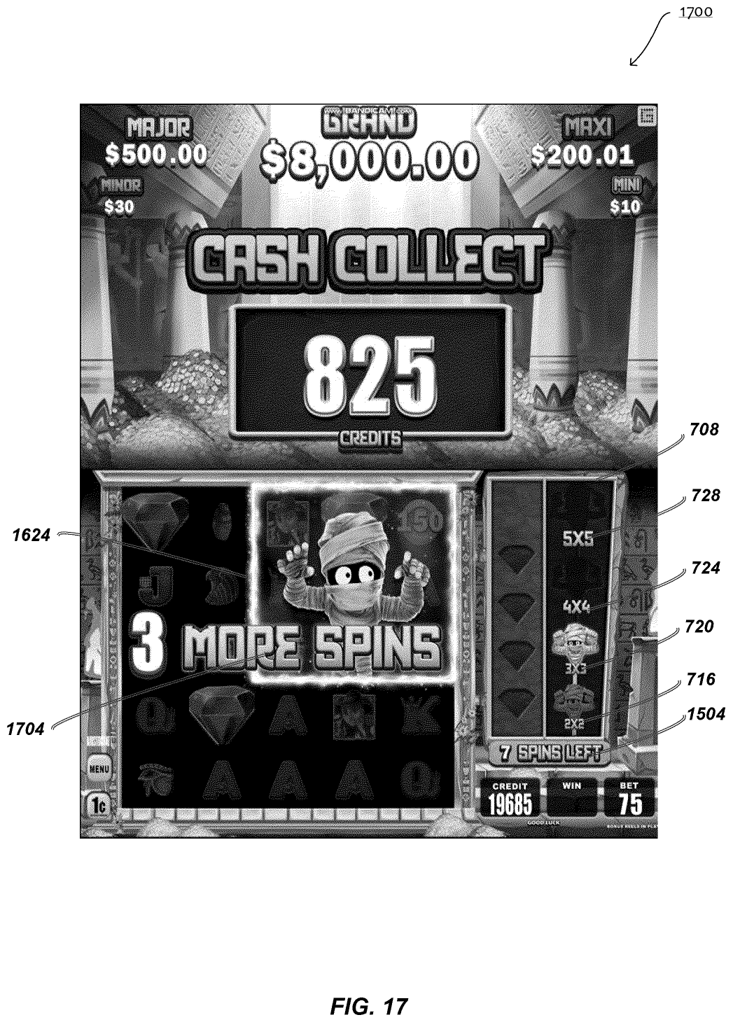

Referring back to FIG. 4, the animated cash collect process 400 proceeds to award a number of free games or free spins at step 4044 when the zone 824 (of FIG. 15) has transformed into the expanded zone 1624. FIG. 17, wherein like numerals refer to like parts, illustrates a screenshot 1700 in which a message 1704 indicating a number of free spins have been awarded, and the spin counter 1504 has been updated to indicate that there are seven free spins remaining. In this regard, the number of free spins to be awarded may be predetermined to satisfy a target volatility criterion or designated RTP.

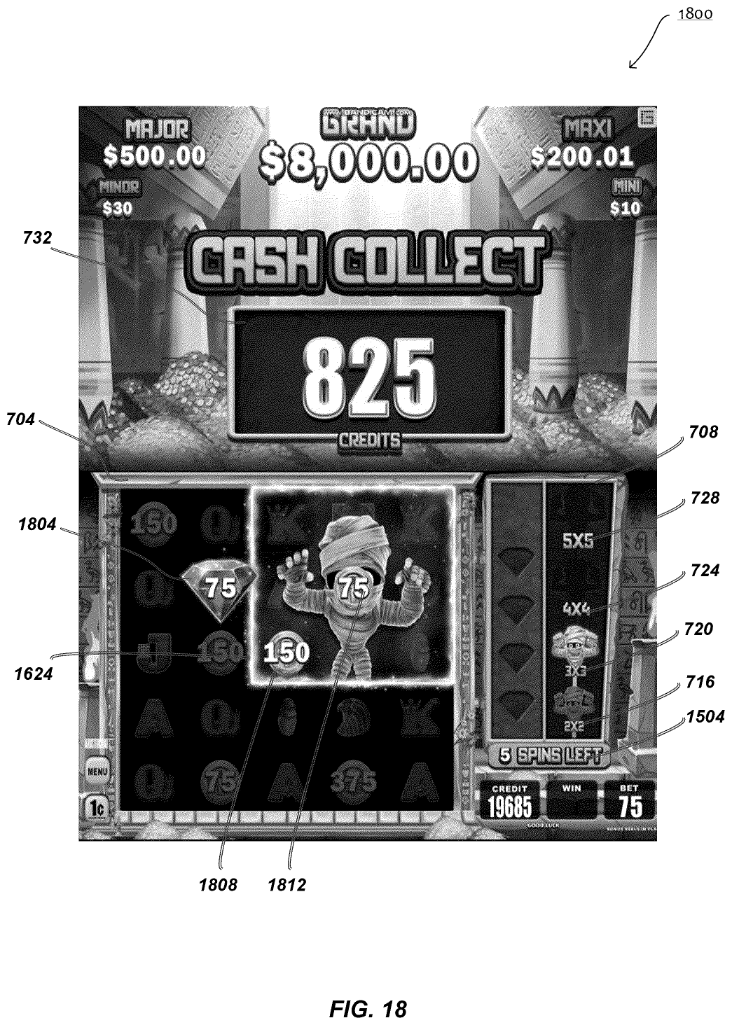

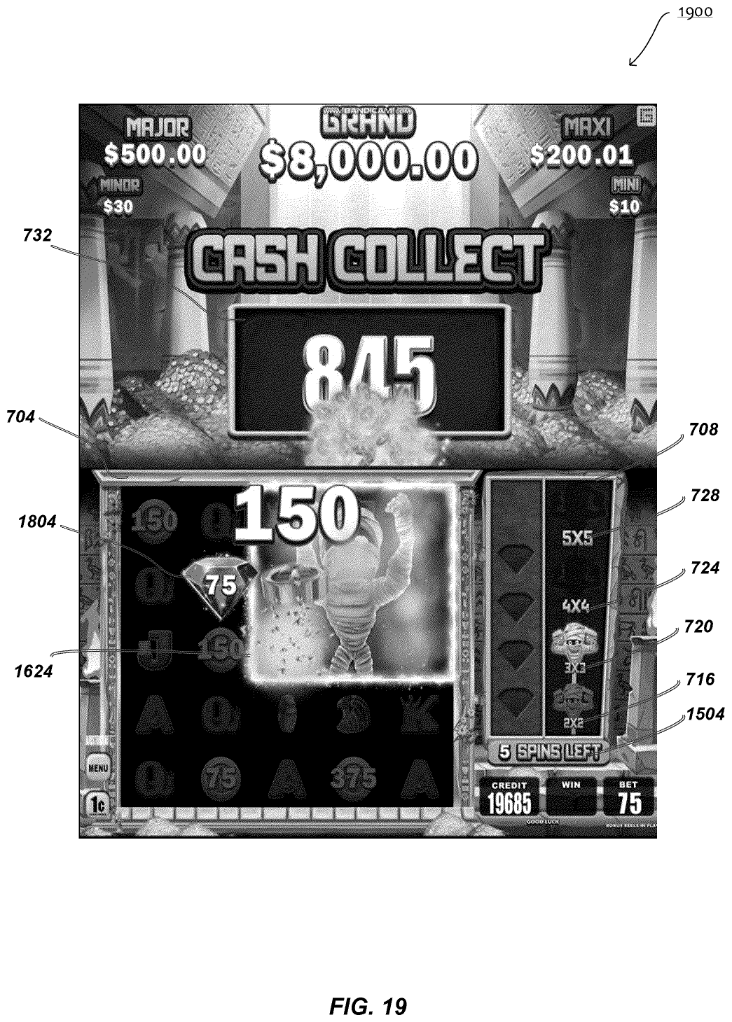

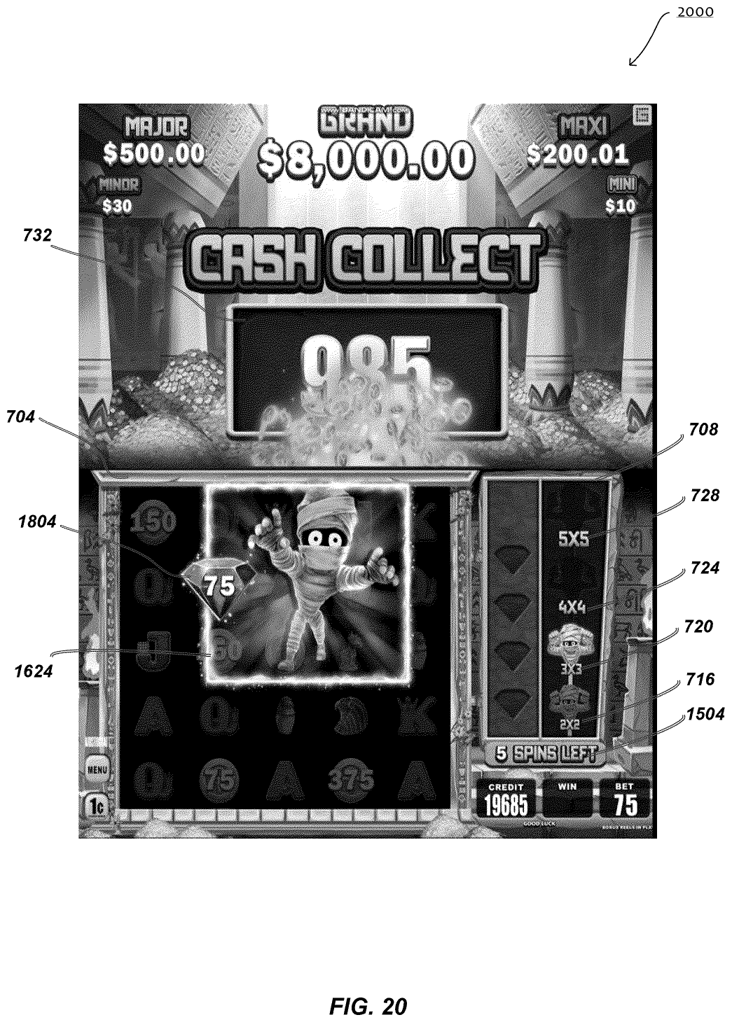

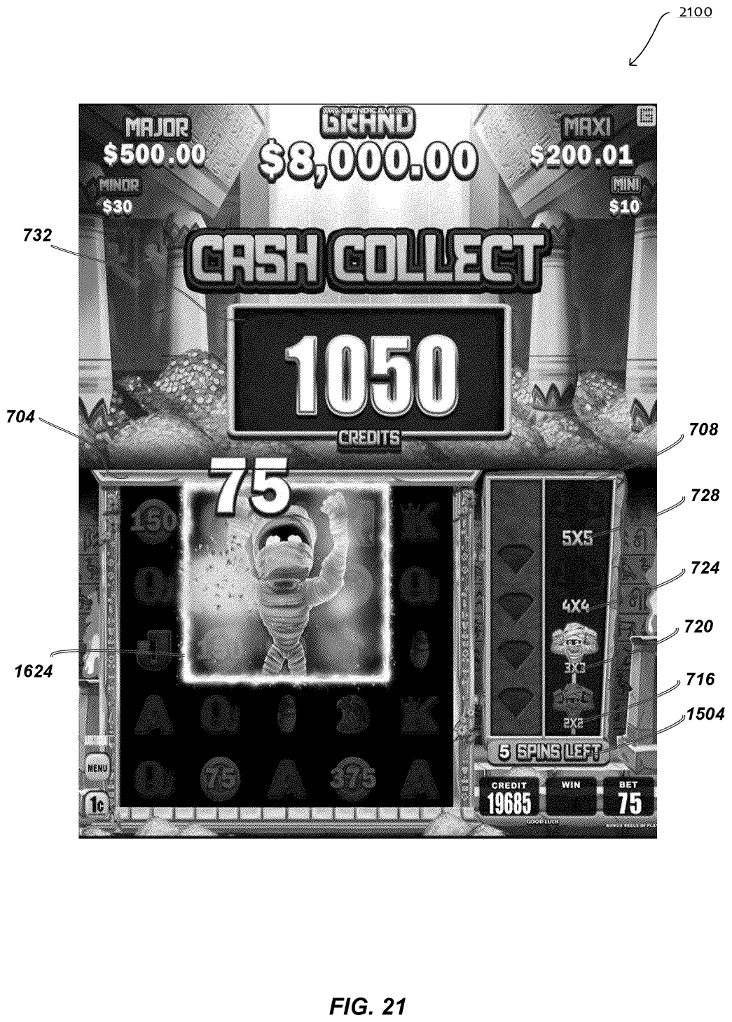

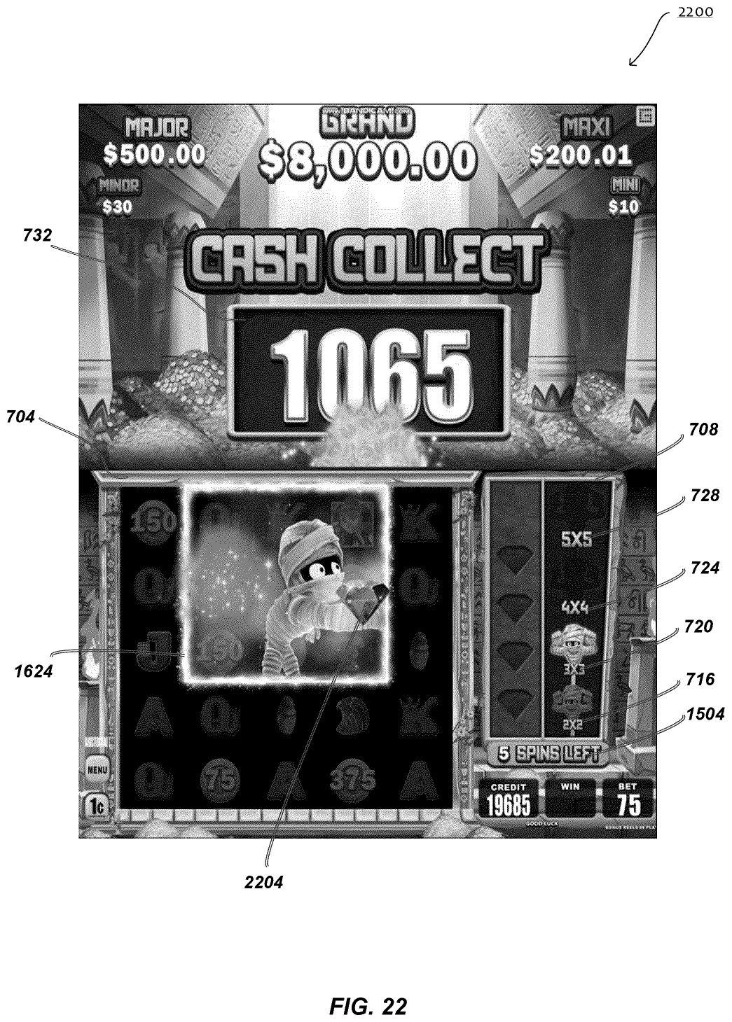

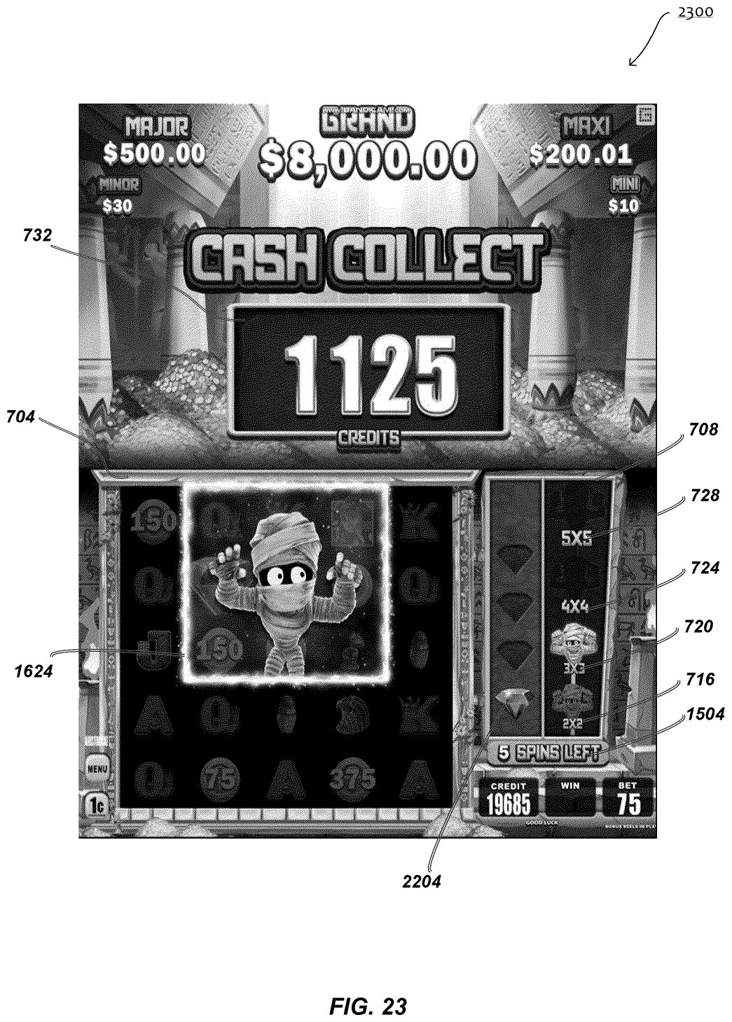

Referring back to FIG. 4, the animated cash collect process 400 proceeds to repeat step 4056 to animate symbols being selected for all the individual reels in the feature game matrix 704. FIG. 18, wherein like numerals refer to like parts, illustrates a screenshot 1800 in which the animated cash collect process 400 displays a plurality of symbols selected for the display positions or individual reels. In some embodiments, the animated cash collect process 400 generally selects symbols for the zone 1624 as discussed above with respect to FIG. 13. As shown in FIG. 18, GEM symbol 1804 and normal COR symbols 1808, 1812 are initially selected for display, while other symbols selected are dimmed. Screenshot 1800 also shows the normal COR symbols 1808, 1812 have landed within the zone 1624. Since normal COR symbols 1808, 1812 have landed in the zone 1624 as determined at step 4060, the normal COR symbols 1808, 1812 are collected, as discussed with respect to step 4016. FIG. 19, wherein like numerals refer to like parts, illustrates a screenshot 1900 in which the normal COR symbols 1808, 1812 are animated as being pulverizing to be collected by the credit counter 732. The normal COR symbols 1808, 1812 as shown in FIG. 18 have assigned values of 150 credits and 75 credits, respectively. FIG. 20, wherein like numerals refer to like parts, illustrates a screenshot 2000 in which the normal COR symbols 1808, 1812 are animated as updating the credit counter 732, as discussed at step 4016, while moving the zone 1624 to capture GEM symbol 1804, as discussed at step 4024. FIG. 21, wherein like numerals refer to like parts, illustrates a screenshot 2100 in which assigned value of GEM symbol 1804 is animated as being extracted from the GEM symbol 1804 as discussed with respect to step 4028, and collected by the credit counter 732, as discussed with respect to step 4032. FIG. 21 also shows that a total of 225 credits has been added to the credit counter 732 that indicates an accumulated total of 1050 credits. FIG. 22, wherein like numerals refer to like parts, illustrates a screenshot 2200 in which a diamond 2204 of GEM symbol 1804 is animated as being flung from the zone 1624 to the counter 708 for collection. FIG. 23, wherein like numerals refer to like parts, illustrates a screenshot 2300 in which 75 credits extracted from GEM symbol 1804 have been added to the credit counter 732 that now reflects an accumulated total of 1125 credits, and that the counter 708 has received the diamond 2204, indicating that three additional diamonds have to be collected for the zone 1624 to advance from the second level 720 to the third level 724, with five free spins remaining at the spin counter 1504.

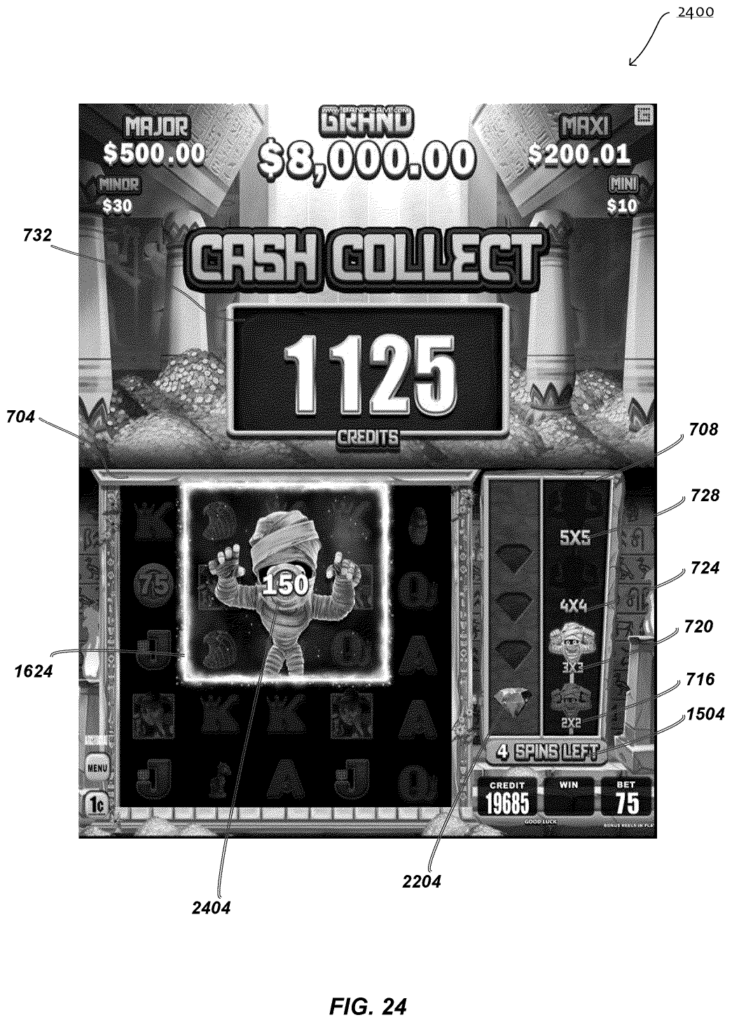

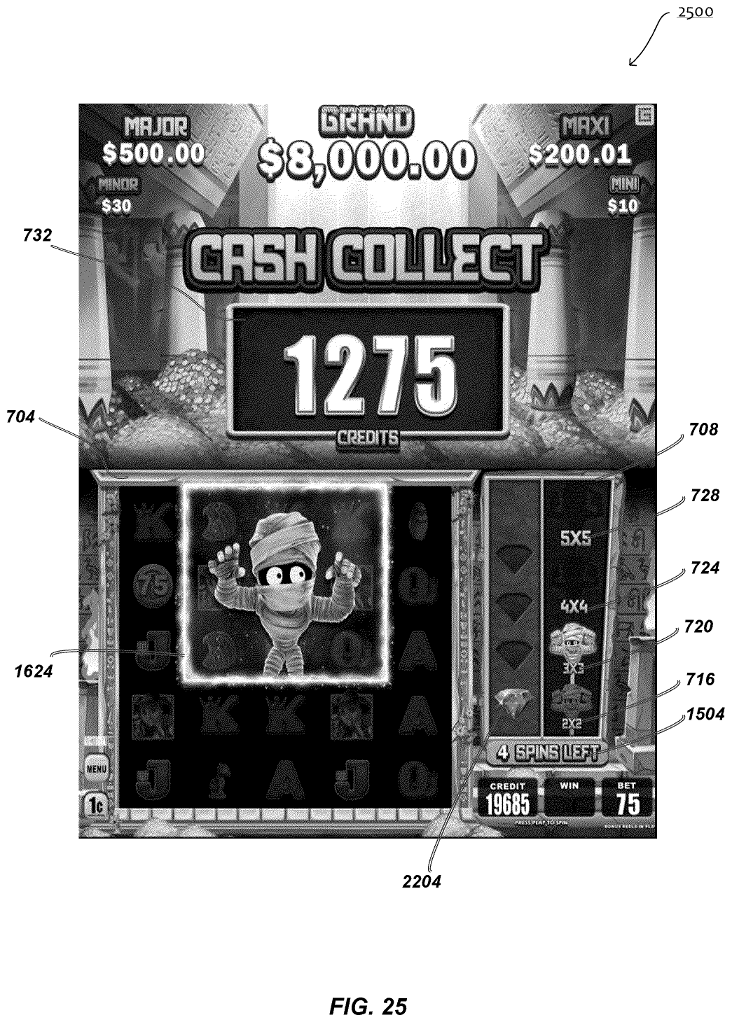

FIG. 24, wherein like numerals refer to like parts, illustrates a screenshot 2400 in which a plurality of symbols have been selected at step 4056 for the display positions or individual reels for the zone 1624 and for the display positions or individual reels outside the zone 1624, as described with respect to FIG. 13. Referring back to FIG. 4, the animated cash collect process 400 proceeds to determine at step 4060 if any normal COR symbol has landed in the zone 1624. Since a normal COR symbol 2404 has landed in the zone 1624, the assigned value of 150 credits is collected, at step 4016, which is reflected as 1275 credits at the credit counter 732 of FIG. 25, wherein like numerals refer to like parts. FIG. 25 also shows there are four spins remaining at the spin counter 1504. Since the display positions or individual reels outside the zone 1624 do not display any GEM symbol (at step 4020), only one diamond (diamond 2204) has been collected for a threshold of four diamonds indicating that the threshold has not been reached (step 4036), and more spins are left (step 4048), the animated cash collect process 400 proceeds to repeat step 4056 again.

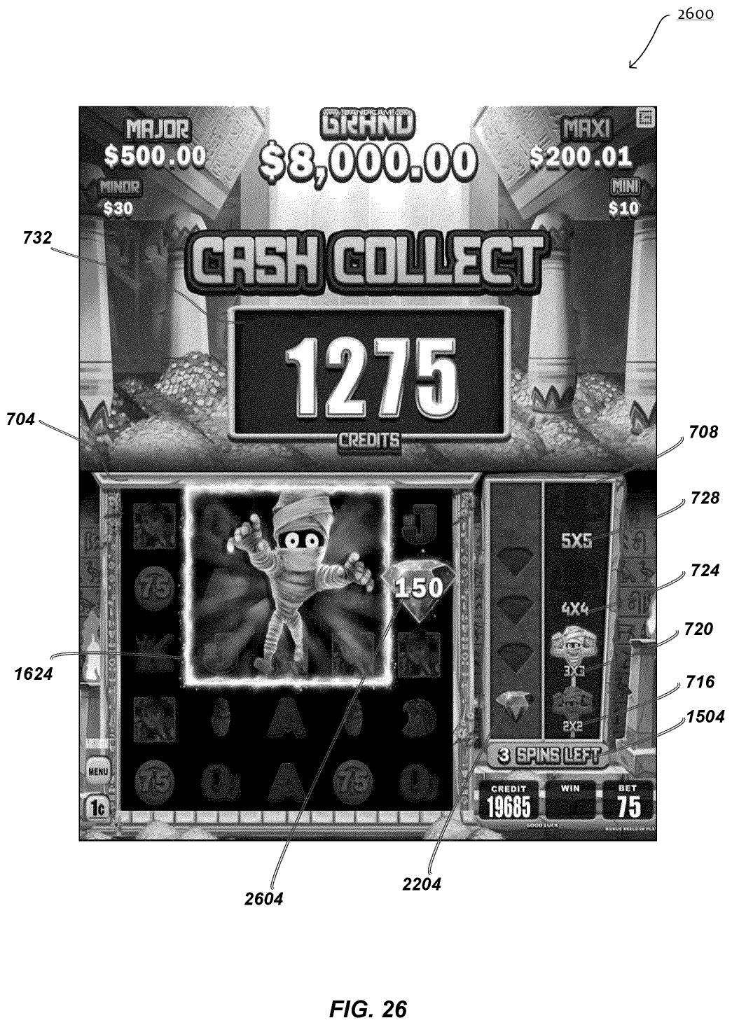

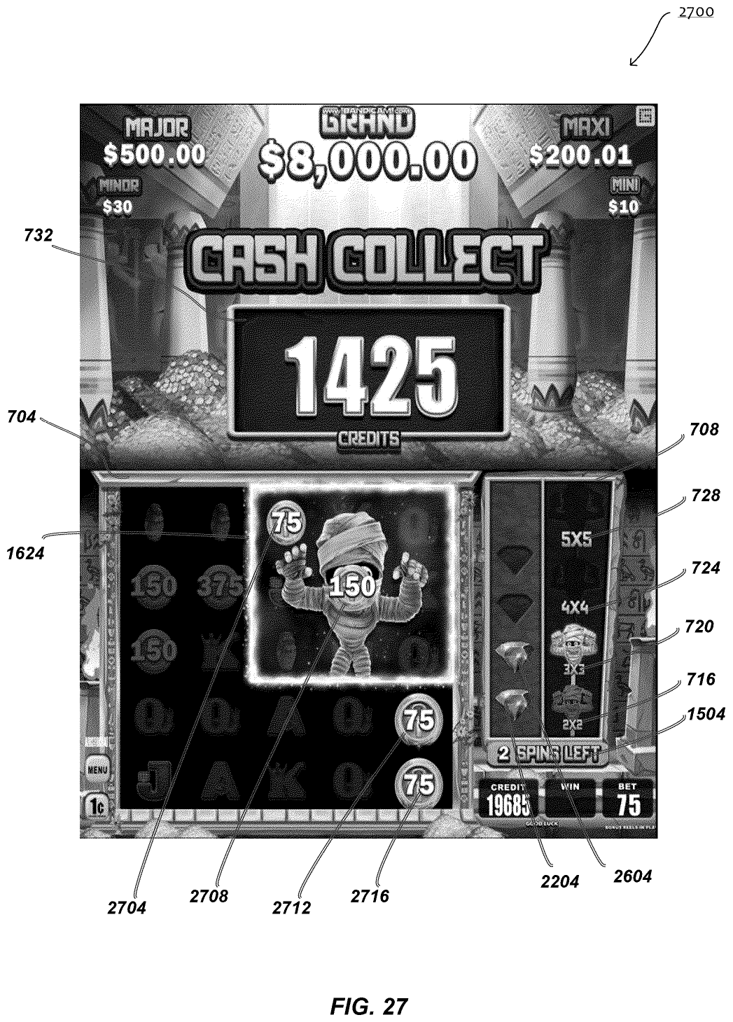

FIG. 26, wherein like numerals refer to like parts, illustrates a screenshot 2600, following screenshot 2500, in which a plurality of symbols have been selected at step 4056 for the display positions or individual reels for the zone 1624 and for the display positions or individual reels outside the zone 1624, as described with respect to FIG. 13. Since the display positions or individual reels in the zone 1624 do not display any normal COR symbol (step 4060), and the display positions or individual reels outside the zone 1624 display GEM symbol 2604 having an assigned value of 150, the animated cash collect process 400 proceeds to animate a zone movement (step 4024), an extraction of the assigned value of 150 for collection at the credit counter 732 (step 4028) indicative of a total of 1425 credits collected (shown in FIG. 27), and a collection of the diamond from the GEM symbol 2604 (step 4032). Since only two diamonds (diamonds 2204, 2604) have been collected for a threshold of four diamonds indicating that the threshold has not been reached (step 4036), and three spins are left (step 4048), the animated cash collect process 400 proceeds to repeat step 4056 again.

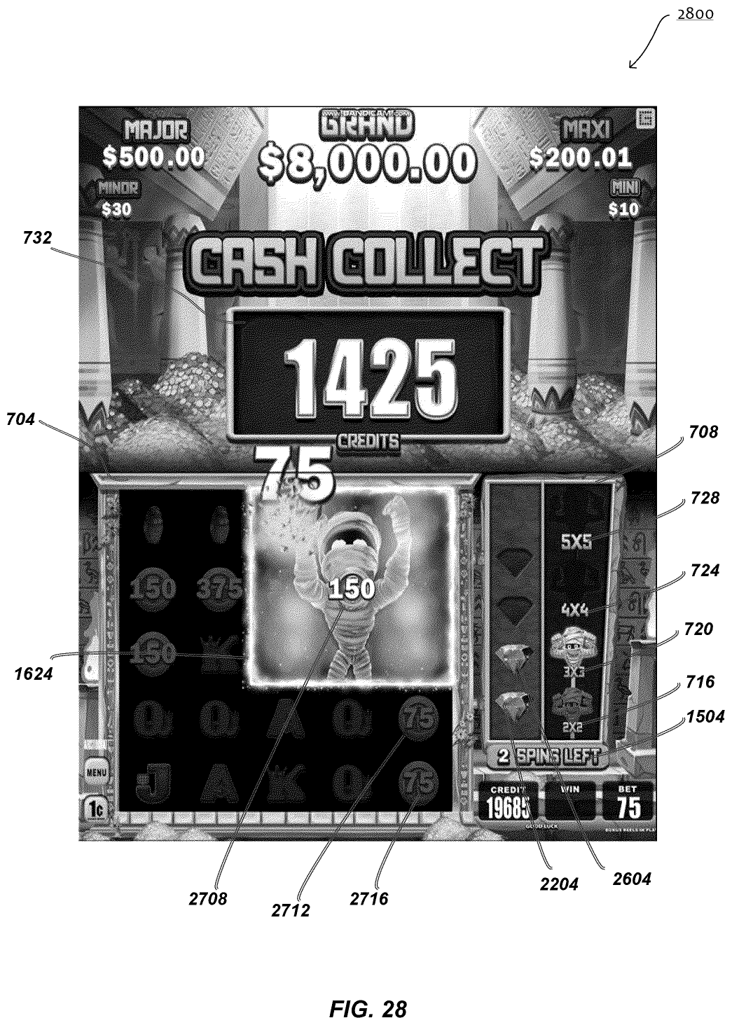

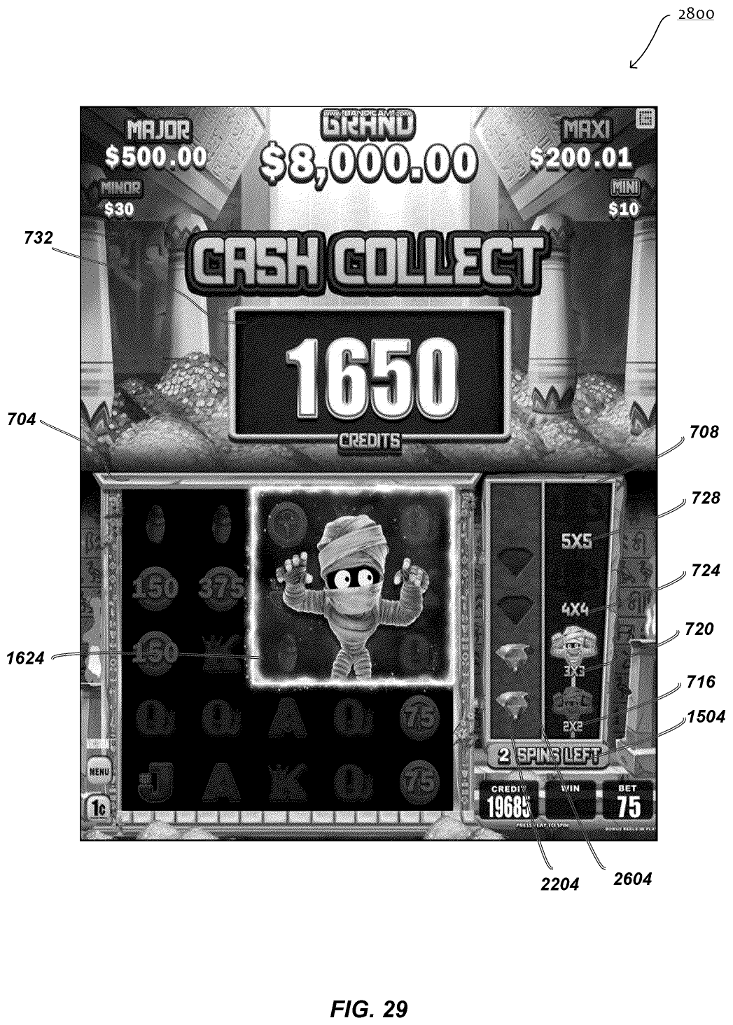

FIG. 27, wherein like numerals refer to like parts, illustrates a screenshot 2700, following screenshot 2600, in which a plurality of symbols have been selected at step 4056 for the display positions or individual reels for the zone 1624 and for the display positions or individual reels outside the zone 1624, as described with respect to FIG. 13. As shown, the display positions or individual reels in the zone 1624 display two normal COR symbols 2704, 2708 (step 4060), and the display positions or individual reels outside the zone 1624 initially display two normal COR symbols 2712, 2716. However, since normal COR symbols 2712, 2716 have landed outside the zone 1624, normal COR symbols 2712, 2716 are subsequently dimmed or deactivated, as shown in FIG. 28. Since the zone 1624 have landed two normal COR symbols 2704, 2708, the animated cash collect process 400 proceeds to step 4016 to extract of collect the two normal COR symbols 2704, 2708, as discussed with respect to FIG. 19. FIG. 29, wherein like numerals refer to like parts, illustrates a screenshot 2900 in which a total of 1650 credits (adding 75 credits and 150 credits to 1425 credits shown in FIG. 28) have been collected at the credit counter 732. Since no GEM symbol has landed outside the zone 1624 (step 4020) with two spins left at the spin counter 1504 (step 4048), the animated cash collect process 400 proceeds to repeat step 4056 again.

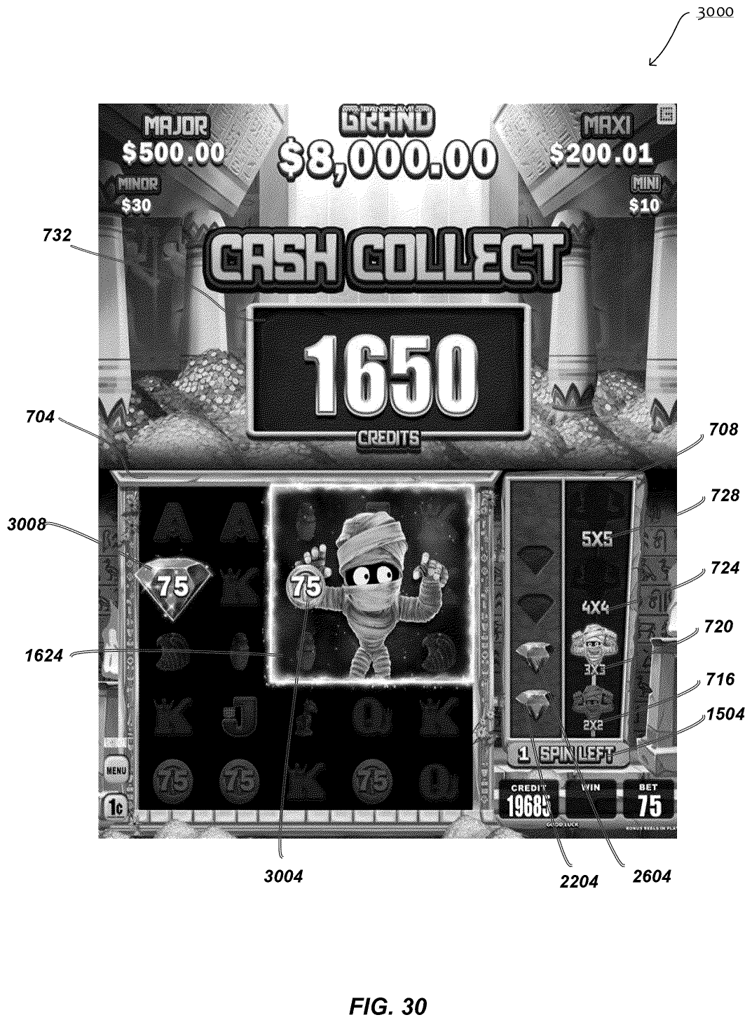

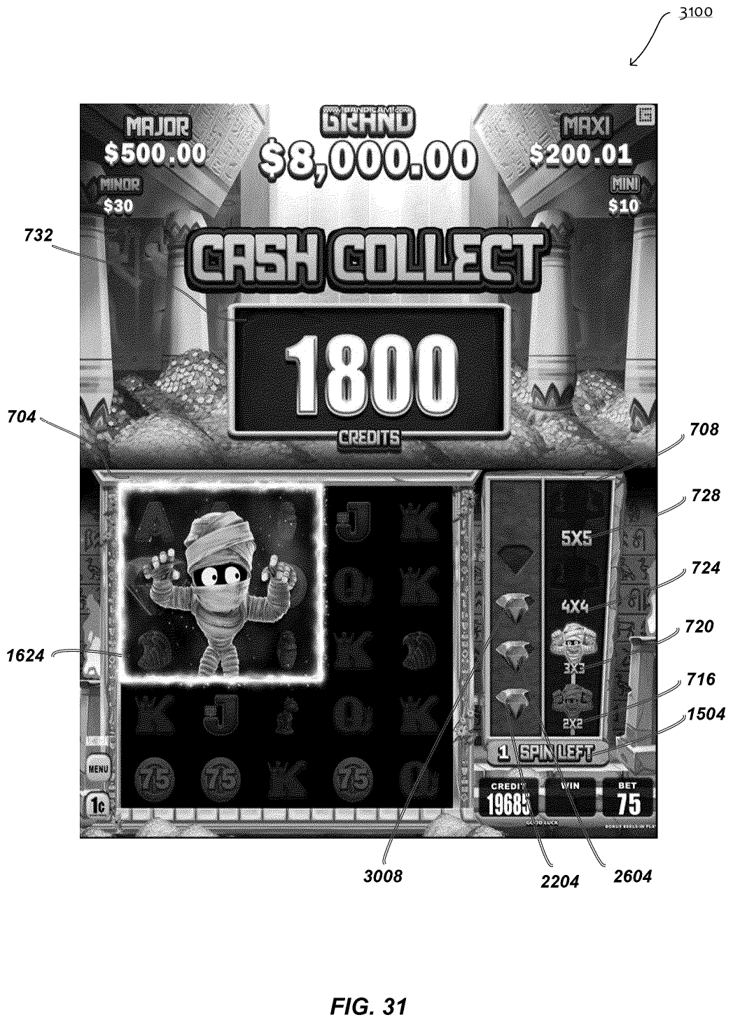

FIG. 30, wherein like numerals refer to like parts, illustrates a screenshot 3000 for the current level of 720, following screenshot 2900, in which a plurality of symbols have been selected at step 4056 for the display positions or individual reels for the zone 1624 and for the display positions or individual reels outside the zone 1624, as described with respect to FIG. 13. As shown, the display positions or individual reels in the zone 1624 display normal COR symbol 3004 (step 4060), and the display positions or individual reels outside the zone 1624 have landed GEM symbol 3008. Since the zone 1624 have landed one normal COR symbol 3004, the animated cash collect process 400 proceeds to step 4016 to extract of collect the assigned value of the normal COR symbol 3008, as discussed with respect to FIG. 19. FIG. 31, wherein like numerals refer to like parts, illustrates a screenshot 3100 in which a total of 1800 credits (adding 75 credits from the COR symbol 3004 and 75 credits from the GEM symbol 3008 to 1650 credits shown in FIG. 29) have been collected at the credit counter 732. FIG. 31 also shows that the zone 1624 has moved, and the diamond extracted from GEM symbol 3008 has been collected at the counter 708, with only one spin left at the spin counter 1504. Thus, if a GEM symbol does not land outside the zone 1624 in the next game instance, the animated cash collect process 400 may be terminated at step 4052. Conversely, if a GEM symbol lands outside the zone 1624 in the next game instance, the animated cash collect process 400 may animate an expansion of the zone 1624 at step 4040 and an increment of the spin counter for more spins at step 4044, before proceeding to repeat step 4056. Thereafter, the animated cash collect process 400 proceeds to repeat step 4056 again.

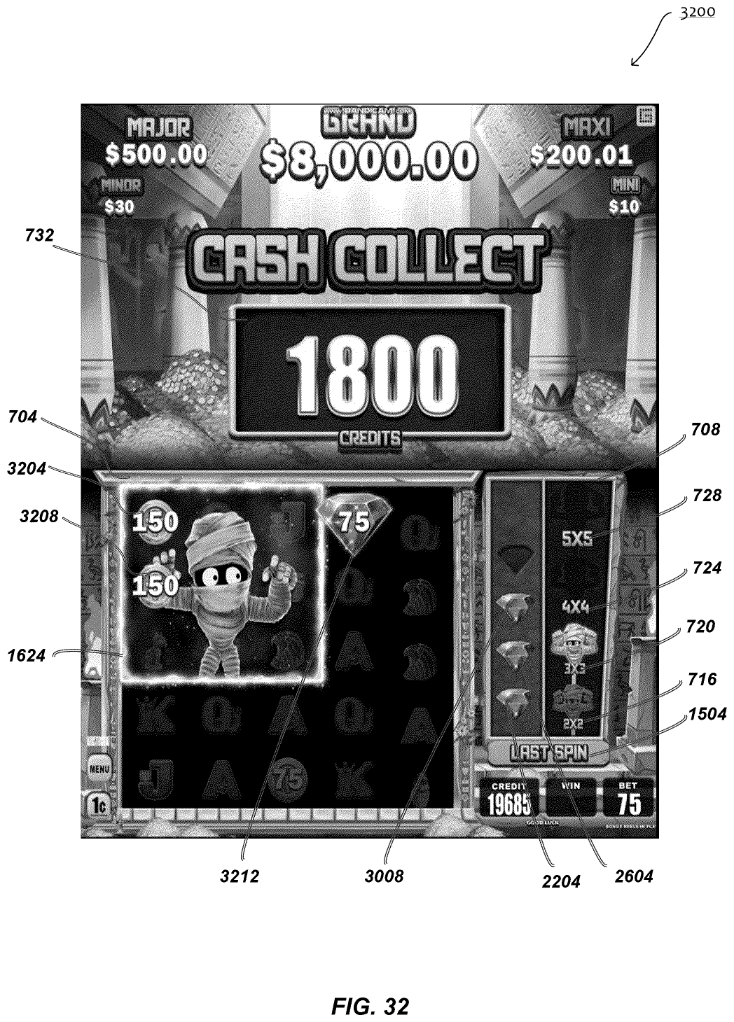

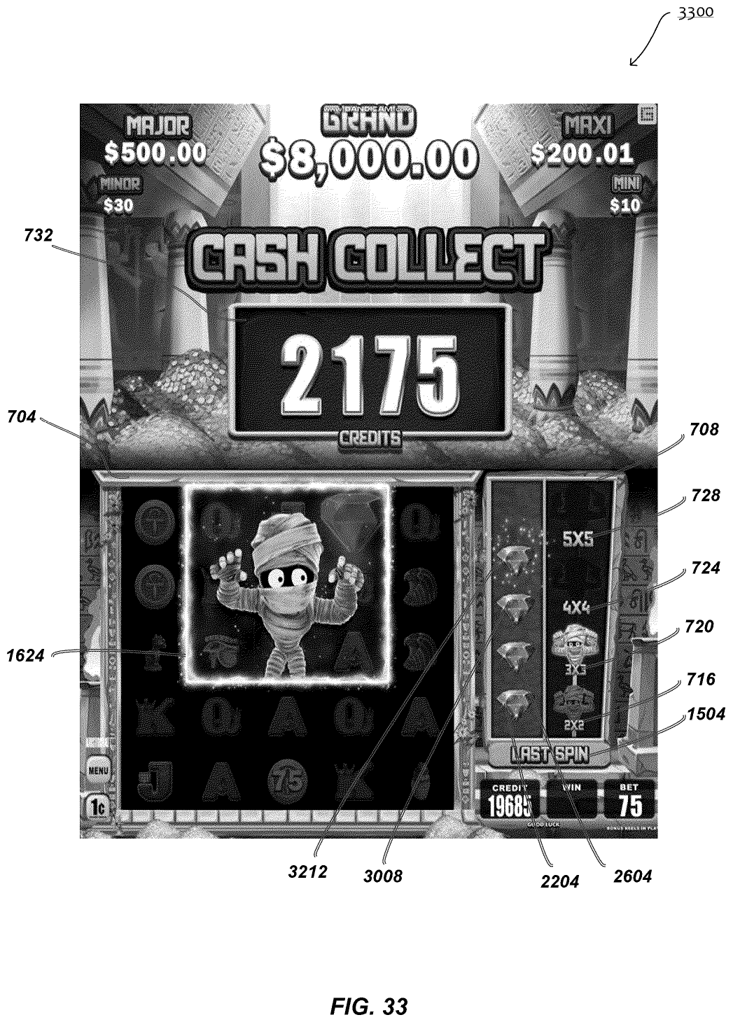

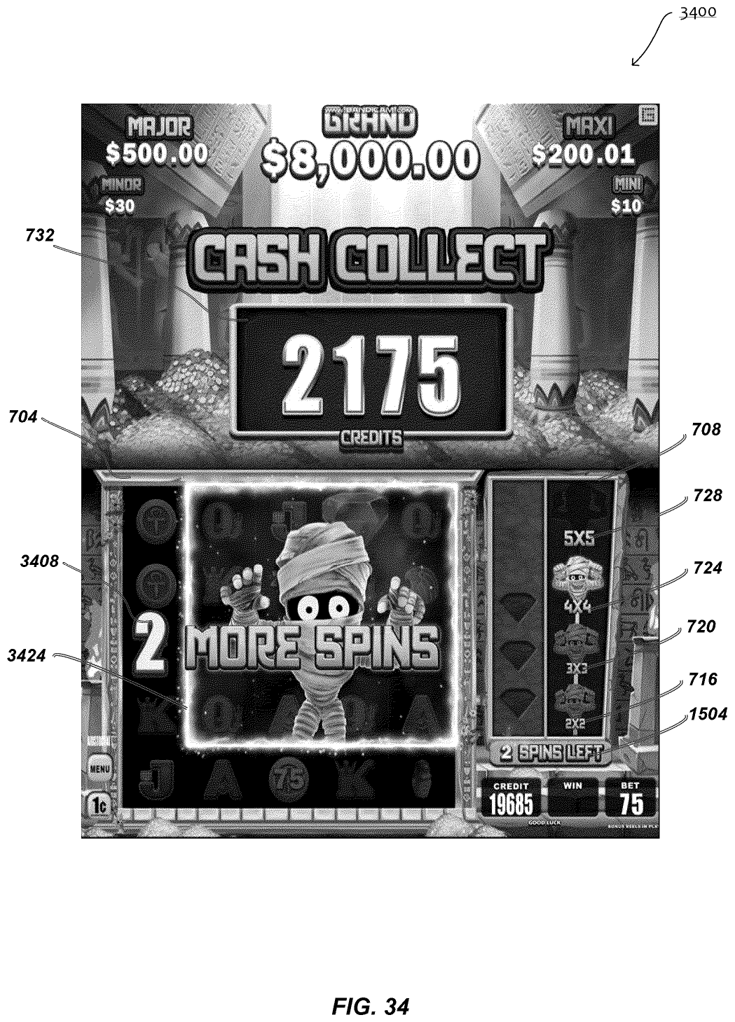

FIG. 32, wherein like numerals refer to like parts, illustrates a screenshot 3200, following screenshot 3100, in which a plurality of symbols have been selected at step 4056 for the display positions or individual reels for the zone 1624 and for the display positions or individual reels outside the zone 1624, as described with respect to FIG. 13. As shown, the display positions or individual reels in the zone 1624 have landed two normal COR symbols 3204, 3208 (step 4060), and the display positions or individual reels outside the zone 1624 initially display GEM symbol 3208. Since the zone 1624 has landed two normal COR symbols 3204, 3208, the animated cash collect process 400 proceeds to step 4016 to extract of collect the two normal COR symbols 3204, 3208, as discussed with respect to FIG. 19. FIG. 33, wherein like numerals refer to like parts, illustrates a screenshot 3300 in which a total of 2175 credits (adding 300 credits from the COR symbols 3204, 3208 and 75 credits from the GEM symbol 3212 to 1800 credits shown in FIG. 32) have been collected at the credit counter 732, and the count at the counter 708 reaches the threshold of four diamonds for the current level 720 at step 4036. FIG. 34, wherein like numerals refer to like parts, illustrates a screenshot 3400 in which the zone 1624 undergoes yet another expansion animation process a second time to yield an expanded zone 3424, while displaying a message 3408 receiving two additional free spins at the spin counter 1504 at step 4044. FIG. 34 also shows that the counter 708 has been reset, the current level has been updated to level 724, and the threshold for level 724 has been defined to be 3 diamonds.

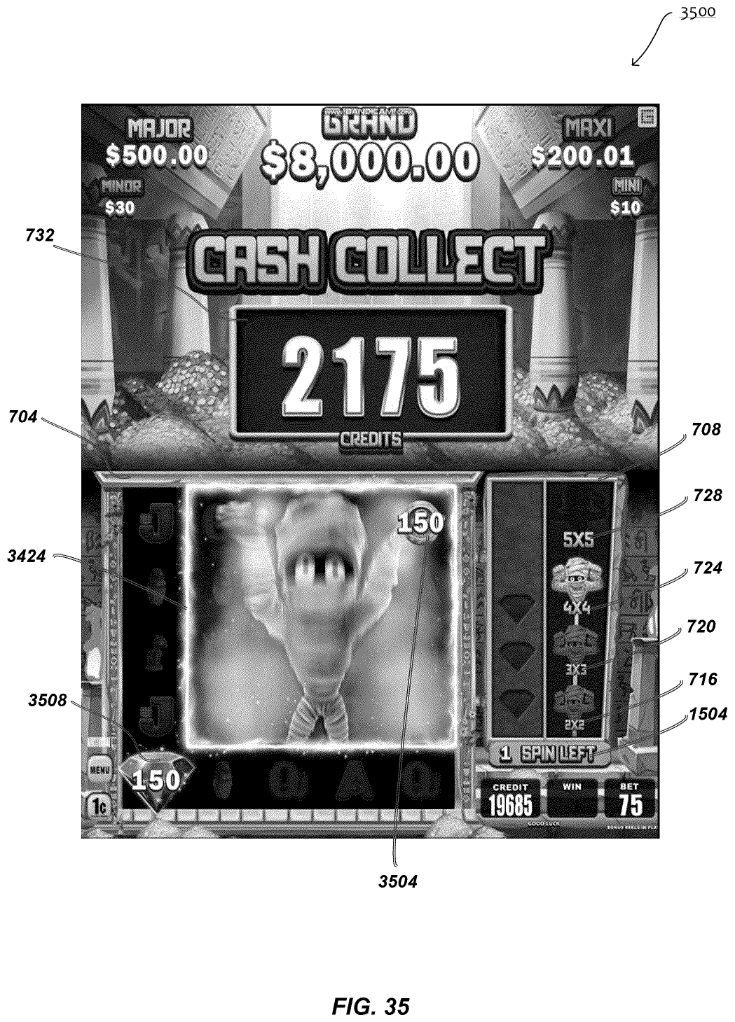

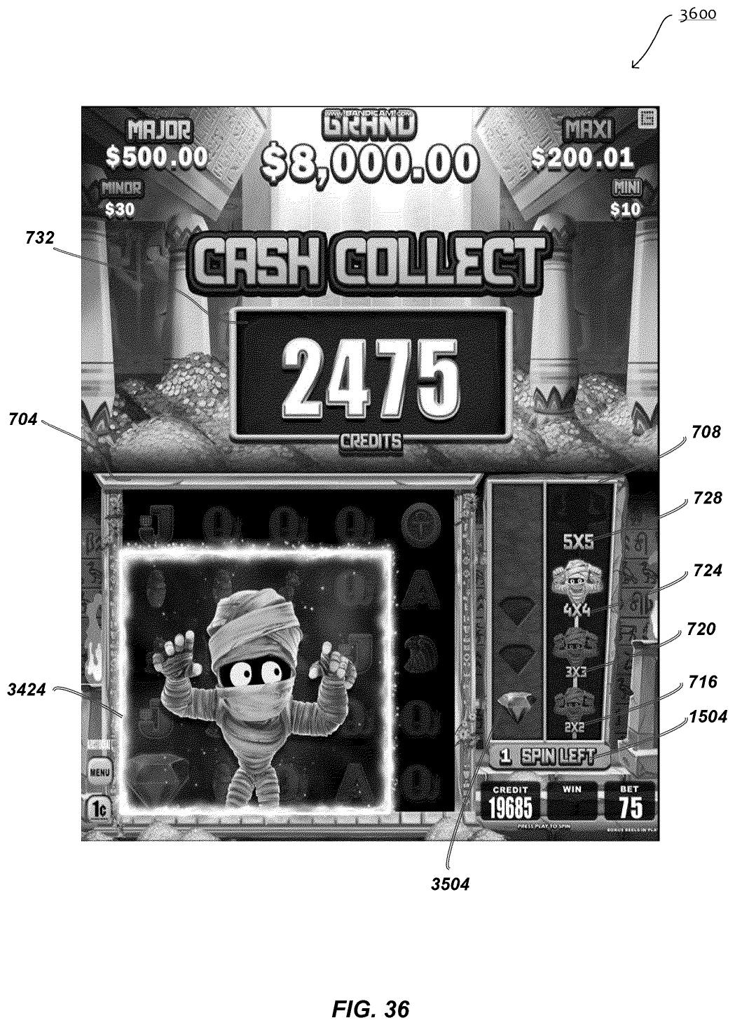

FIG. 35, wherein like numerals refer to like parts, illustrates a screenshot 3500, following screenshot 3400, in which a plurality of symbols have been selected at step 4056 for the display positions or individual reels for the expanded zone 3424 and for the display positions or individual reels outside the expanded zone 3424, as described with respect to FIG. 13. As shown, the display positions or individual reels in the expanded zone 3424 have landed normal COR symbol 3504 (step 4060), and the display positions or individual reels outside the expanded zone 3424 land GEM symbol 3508. Since the expanded zone 3424 has landed the normal COR symbol 3604, the animated cash collect process 400 proceeds to step 4016 to extract of collect the assigned value of 150 credits from the COR symbols 3604, as discussed with respect to FIG. 19. FIG. 36, wherein like numerals refer to like parts, illustrates a screenshot 3600 in which a total of 2475 credits (adding 150 credits from the COR symbol 3604 and 150 credits from the GEM symbol 3608 to 2175 credits shown in FIG. 35) have been collected at the credit counter 732, and the count at the counter 708 is registered at one diamond for the current level 724 at step 4036. Since there is an additional spin left at the spin counter 1504 (step 4048), the animated cash collect process 400 proceeds to repeat step 4056 again.

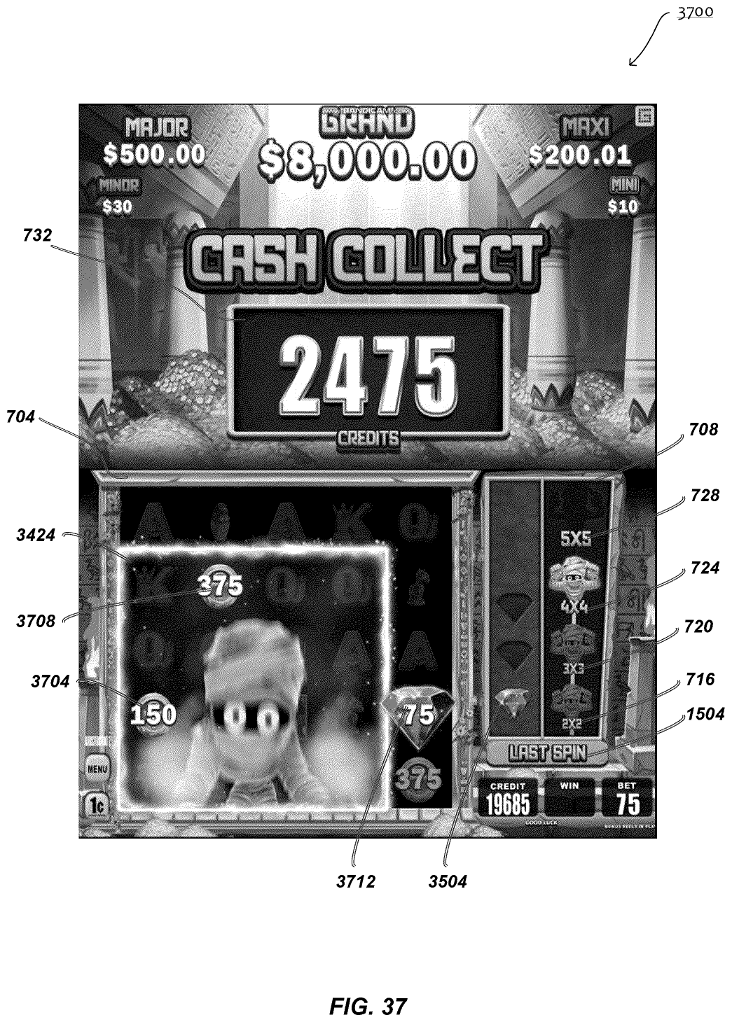

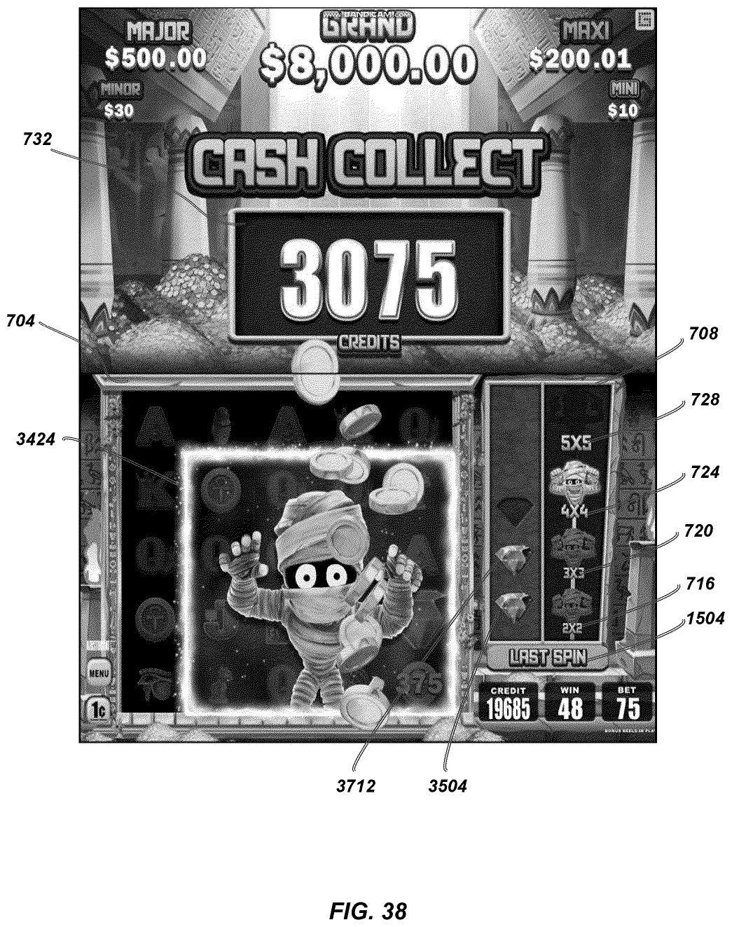

FIG. 37, wherein like numerals refer to like parts, illustrates a screenshot 3700 for the current level of 724 in which a plurality of symbols have been selected at step 4056 for the display positions or individual reels for the expanded zone 3424 and for the display positions or individual reels outside the expanded zone 3424, as described with respect to FIG. 13. As shown, the display positions or individual reels in the expanded zone 3424 display two normal COR symbols 3704, 3708 (step 4060), and the display positions or individual reels outside the expanded zone 3424 have landed GEM symbol 3712. Since the expanded zone 3424 have landed two normal COR symbols 3704, 3708, the animated cash collect process 400 proceeds to step 4016 to extract of collect the assigned values of the two normal COR symbols 3704, 3708, as discussed with respect to FIG. 19. FIG. 38, wherein like numerals refer to like parts, illustrates a screenshot 3800 in which a total of 3075 credits (adding 150 credits and 375 credits from the normal COR symbols 3704, 3708 and 75 credits from the GEM symbol 3008 to 2475 credits shown in FIG. 37) have been collected at the credit counter 732. FIG. 38 also shows that the expanded zone 3424 has moved, and the diamond extracted from GEM symbol 3712 has been collected at the counter 708, with no additional spin left at the spin counter 1504. Thus, the animated cash collect process 400 may be terminated at step 4052.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A gaming system comprising:
a display device comprising a plurality of display positions; and
a gaming controller having a processor and memory having a first set of symbols including a plurality of first symbols, a second set of symbols including a plurality of second symbols different from the plurality of first symbols, each of the first symbols and the second symbols having one of a plurality of values, and one or more sequences of instructions, which, when executed, cause the processor to at least:
control the display device to animate a zone among the plurality of display positions including a plurality of zone display positions, and a count of the plurality of first symbols collected outside the zone,
control the display device to animate, for a current instance, a first plurality of symbols selected from the first set of symbols and a second plurality of symbols selected from the second set of symbols for the plurality of display positions, based on a plurality of random numbers generated by a random number generator,
control the display device to animate the values of the second symbols selected for the zone being collected, and the zone being moved based on the first symbols selected outside the zone to acquire the first symbols for an increment of the count, and
control the display device for a next instance to animate the zone being expanded into an expanded zone when the count reaches a threshold.

2. The gaming system of claim 1, further comprising the one or more sequences of instructions, when executed, causing the processor to control the display device to animate the zone being moved in a predetermined path or randomly towards each of the first symbols.

3. The gaming system of claim 2, further comprising the one or more sequences of instructions, when executed, causing the processor to control the display device to animate each of the values assigned to each of the first symbols being collected when the zone overlaps each of the first symbols.

4. The gaming system of claim 1, further comprising the one or more sequences of instructions, when executed, causing the processor to award a predetermined plurality of instances when the count reaches the threshold.

5. The gaming system of claim 1, further comprising the one or more sequences of instructions, when executed, causing the processor to dynamically assign the values to the first symbols and the second symbols for at least one instance.

6. The gaming system of claim 1, further comprising the one or more sequences of instructions, when executed, causing the processor to dynamically adjust the threshold based on the plurality of zone display positions in the zone.

7. The gaming system of claim 1, further comprising the one or more sequences of instructions, when executed, causing the processor to shuffle the first set of symbols and the second set of symbols for the plurality of display positions prior to the current instance.

8. A method of operating a gaming system having a display device providing a matrix comprising an initial plurality of display positions, and a server having a processor and memory having a first set of symbols, a second set of symbols including a plurality of second symbols, a third set of symbols including a plurality of third symbols different from the plurality of second symbols, each of the second symbols and the third symbols having one of a plurality of values, and one or more sequences of instructions, which, when executed, cause the processor to at least to initiate a game, the method comprising:
animating a first plurality of symbols selected from the first set of symbols for display at the initial plurality of display positions in the matrix based on a plurality of random numbers generated by a random number generator;
animating an expansion of the matrix into an expanded matrix to include an expanded plurality of display positions having an expandable zone that comprises a plurality of zone display positions operable to move towards the second symbols, and a counter indicative of the plurality of second symbols collected outside the expandable zone, when the first plurality of symbols selected include a trigger event;
animating, for a current instance, a second plurality of symbols selected from the second set of symbols and a third plurality of symbols selected from the third set of symbols for the expanded matrix, based on the random numbers generated;
animating the values of the third symbols selected for the expandable zone being collected, and the expandable zone being moved based on the second symbols selected outside the expandable zone to acquire the second symbols for an increment of the counter in a predetermined path or randomly; and
animating, for a next instance, the expandable zone being expanded into an expanded zone when the counter reaches a threshold.

9. The method of claim 8, further comprising animating each of the values assigned to each of the second symbols being collected when the expandable zone overlaps each of the second symbols.

10. The method of claim 8, further comprising awarding a predetermined plurality of instances when the counter indicates that the threshold has been reached.

11. The method of claim 8, further comprising dynamically assigning the values to the third symbols and the second symbols.

12. The method of claim 8, further comprising dynamically adjusting the threshold based on the plurality of zone display positions in the expandable zone.

13. The method of claim 8, further comprising shuffling the second set of symbols and the third set of symbols for the expanded plurality of display positions prior to the current instance.

14. A non-transitory computer-readable medium for conducting a game on an electronic gaming device that includes a display device providing a matrix comprising an initial plurality of display positions, and a gaming controller having a processor, and for storing a first set of symbols, a second set of symbols including a plurality of second symbols, a third set of symbols including a plurality of third symbols different from the plurality of second symbols, each of the second symbols and the third symbols having one of a plurality of values, and one or more sequences of instructions, which, when executed cause the processor to perform at least the steps of:
selecting a first plurality of symbols from the first set of symbols for display in the matrix based on a plurality of random numbers generated by a random number generator;
expanding the matrix into an expanded matrix to include an expanded plurality of display positions and a zone having a plurality of zone display positions, and to animate a counter indicative of the plurality of second symbols collected outside the zone, when the first plurality of symbols selected include a trigger event;
initiating a current instance of the game including animating a second plurality of symbols being selected from the second set of symbols and a third plurality of symbols selected from the third set of symbols for the expanded plurality of display positions in the expanded matrix, based on the random numbers generated;
animating on the display device the values of the third symbols selected for the zone being collected, and the zone being moved based on the second symbols selected outside the zone to acquire the second symbols for an increment of the count; and
initiating a next instance including animating the zone being expanded into an expanded zone when the count reaches a threshold.

15. The non-transitory computer-readable medium of claim 14, wherein the one or more sequences of instructions, when executed, further cause the processor to perform the step of animating the zone being moved in a predetermined path or randomly towards each of the second symbols.

16. The non-transitory computer-readable medium of claim 15, wherein the one or more sequences of instructions, when executed, further cause the processor to perform the step of animating each of the values assigned to each of the second symbols being collected when the zone overlaps each of the second symbols.

17. The non-transitory computer-readable medium of claim 14, wherein the one or more sequences of instructions, when executed, further cause the processor to perform the step of presenting an award of a predetermined plurality of instances when the counter indicates that the threshold has been reached.

18. The non-transitory computer-readable medium of claim 14, wherein the one or more sequences of instructions, when executed, further cause the processor to perform the step of dynamically assigning the values to the third symbols and the second symbols.

19. The non-transitory computer-readable medium of claim 14, wherein the one or more sequences of instructions, when executed, further cause the processor to perform the step of dynamically adjusting the threshold based on the plurality of zone display positions in the zone.

20. The non-transitory computer-readable medium of claim 14, wherein the one or more sequences of instructions, when executed, further cause the processor to perform the step of shuffling the second set of symbols and the third set of symbols for the expanded plurality of display positions prior to the current instance.
